(19) United States
(12) Patent Application Publication
(10) Pub. No.: US 2024/0369369 A1
(43) Pub. Date: Nov. 7, 2024

(54) SYSTEMS AND METHODS FOR ACCESSIBLE VEHICLES

(71) Applicant: Intel Corporation, Santa Clara, CA (US)

(72) Inventors: Chien Chern Yew, Penang (MY); Say Chuan Tan, Penang (MY); Yang Peng, Munich (DE); Devamekalai Nagasundaram, Jawi (MY); Florian Geissler, Munich (DE); Michael Paulitsch, Ottobrunn (DE); Ying Wei Liew, Penang (MY)

(21) Appl. No.: 18/572,578

(22) PCT Filed: Sep. 23, 2021
(86) PCT No.: PCT/US2021/051788

§ 371 Date: Dec. 20, 2023

(51) Int. Cl. G01C 21/34; B60W 50/00; G06V 20/59; G06V 40/16

(52) U.S. Cl. CPC G01C 21/3484; B60W 50/0098; G06V 20/59; G06V 40/16

(57) ABSTRACT

Disclosed herein are embodiments of systems and methods for accessible vehicles (e.g., accessible autonomous vehicles). In an embodiment, a passenger-assistance system for a vehicle includes first circuitry, second circuitry, third circuitry, and fourth circuitry. The first circuitry is configured to identify an assistance type of a passenger of the vehicle. The second circuitry is configured to control one or more passenger-comfort controls of the vehicle based on the identified assistance type. The third circuitry is configured to generate a modified route for a ride for the passenger at least in part by modifying an initial route for the ride based on the identified assistance type. The fourth circuitry is conduct a pre-ride safety check and/or a pre-exit safety check based on the identified assistance type.

### TECHNICAL FIELD

Embodiments of the present disclosure relate to autonomous vehicles and other vehicles, on-demand-ride services, machine learning, accessibility technology, and, more particularly, to systems and methods for accessible vehicles.

### BACKGROUND

In today's modern society, many people use many different forms of transportation for many different reasons. Furthermore, the length of trips that people take using various forms of transportation varies widely, from local trips around a particular city to cross-country and international travel, as examples. In many of these cases, various different passengers would benefit from some assistance in making their particular journey. Examples of such passengers include those that are quite young, those that are on the older side, those that have a disability of some sort, those that are injured, those that are sick, those that are just visiting (e.g., tourists), and so on. Including but without being limited to the examples given in the previous sentence, these passengers are referred to in the present disclosure as “assistance passengers.” Every effort has been made in the present disclosure to use respectful terminology, and any failure to do that successfully is purely accidental and unintended.

### BRIEF DESCRIPTION OF THE DRAWINGS

A more detailed understanding may be had from the following description, which is presented by way of example in conjunction with the following drawings, in which like reference numerals are used across the drawings in connection with like elements.

FIG. 1 depicts an example accessible-ride process flow, in accordance with at least one embodiment.

FIG. 2 depicts an example passenger-assistance system for a vehicle, in accordance with at least one embodiment.

FIG. 3 depicts an example architecture of the example assistance-type detection unit of the example passenger-assistance system of FIG. 2, in accordance with at least one embodiment.

FIG. 4 depicts an example trip-planner process flow for an example trip-planning unit of the example passenger-assistance system of FIG. 2, in accordance with at least one embodiment.

FIG. 5 depicts a first example method, in accordance with at least one embodiment.

FIG. 6 depicts an example multi-passenger-vehicle process flow, in accordance with at least one embodiment.

FIG. 7 depicts a first example accessible-vehicle scenario, in accordance with at least one embodiment.

FIG. 8 depicts a second example accessible-vehicle scenario, in accordance with at least one embodiment.

FIG. 9 depicts a second example method, in accordance with at least one embodiment.

FIG. 10 depicts an example architecture diagram for cloud-based management of a fleet of accessible vehicles, in accordance with at least one embodiment.

FIG. 11 depicts a third example method, in accordance with at least one embodiment.

FIG. 12 depicts an example computer system, in accordance with at least one embodiment.

FIG. 13 depicts an example software architecture that could be executed on the example computer system of FIG. 12, in accordance with at least one embodiment.

### DETAILED DESCRIPTION

In accordance with embodiments of present disclosure, in an inclusive modern society, accessible vehicles, which in the on-demand-ride (e.g., rideshare) context are sometimes referred to by other terms such as “robotaxis” (autonomous vehicles which can be booked for taxi uses), air taxis (autonomous UAVs which can be booked for taxi uses) or shared vehicles (including buses, trains, ships, airplanes), identify assistance passengers. In many instances in this disclosure, the term “robotaxi” is used by way of example, though embodiments of present disclosure apply more generally to other types of vehicles, including air taxis, buses, trains, ships, airplanes. Embodiments of the present disclosure improve the ways in which assistance passengers interact with—and are assisted by—robotaxis, which provide assistance to assistance passengers in ways that are personalized and therefore particularly helpful to those passengers.

For example, in at least one embodiment, an accessible autonomous vehicle informs a visually-impaired (e.g., fully or partially blind) passenger as to their location and also as to safety-relevant aspects with respect to the surrounding environment when that passenger is entering and/or when that passenger exiting the vehicle. Moreover, in at least one embodiment, the accessible autonomous vehicle selects an accessible location at which to drop off the passenger. Other aspects of various different embodiments are further discussed below, including assistance-passenger-specific trip planning, learning from passenger feedback, personalizing and localizing assistance to assistance passengers in the context of multi-passenger (e.g., public-transportation) accessible autonomous vehicles, providing assistance specifically in the context of very young children, and others.

Disclosed herein are embodiments of systems and methods for accessible vehicles. One example embodiment takes the form of a passenger-assistance system for a vehicle. The passenger-assistance system includes first circuitry configured to perform one or more first-circuitry operations including identifying an assistance type of a passenger of the vehicle, as well as second circuitry configured to perform one or more second-circuitry operations including controlling one or more passenger-comfort controls of the vehicle based on the identified assistance type. The passenger-assistance system also includes third circuitry configured to perform one or more third-circuitry operations including generating a modified route for a ride for the passenger at least in part by modifying an initial route for the ride based on the identified assistance type. The passenger-assistance system also includes fourth circuitry configured to perform one or more fourth-circuitry operations including one or both of conducting a pre-ride safety check based on the identified assistance type and conducting a pre-exit safety check based on the identified assistance type.

As described herein, one or more embodiments of the present disclosure take the form of methods that include multiple operations. One or more other embodiments take the form of systems that include at least one hardware processor and that also include one or more non-transitory computer-readable storage media containing instructions that, when executed by the at least one hardware processor, cause the at least one hardware processor to perform multiple operations (that in some embodiments do and in other embodiments do not correspond to operations performed in a herein-disclosed method embodiment). Still one or more other embodiments take the form of one or more non-transitory computer-readable storage media (CRM) containing instructions that, when executed by at least one hardware processor, cause the at least one hardware processor to perform multiple operations (that, similarly, in some embodiments do and in other embodiments do not correspond to operations performed in a herein-disclosed method embodiment and/or operations performed by a herein-disclosed system embodiment).

Furthermore, a number of variations and permutations of embodiments are described herein, and it is expressly noted that any variation or permutation that is described in this disclosure can be implemented with respect to any type of embodiment. For example, a variation or permutation that is primarily described in this disclosure in connection with a method embodiment could just as well or instead be implemented in connection with a system embodiment and/or a CRM embodiment. Furthermore, this flexibility and cross-applicability of embodiments is present in spite of any slightly different language (e.g., processes, methods, methodologies, steps, operations, functions, and/or the like) that is used to describe and/or characterize such embodiments and/or any element or elements thereof.

Moreover, although most of the example embodiments that are presented in this disclosure relate to autonomous vehicles, many aspects of embodiments of the present disclosure also apply to vehicles that are driven (or piloted, etc.) by a human operator. Additionally, in some embodiments, the vehicle is a manually operated vehicle (e.g., a vehicle that is controlled remotely, a train that is operated by a driver that can not leave the engine car (and where the train may be otherwise unstaffed, though it could be staffed)). Indeed, in some vehicles, the embodiments of the present disclosure may function autonomously as described herein; in other vehicles (e.g., those operated by a person), embodiments of the present disclosure may involve making recommendations to the driver. Such recommendations could relate to suggested routes, suggested adjustments to make for passenger comfort, suggested drop-off locations, and/or the like.

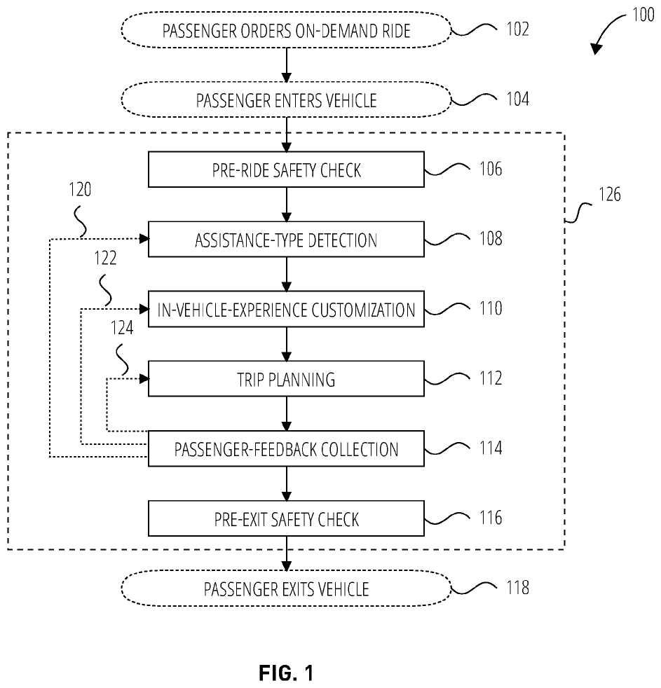

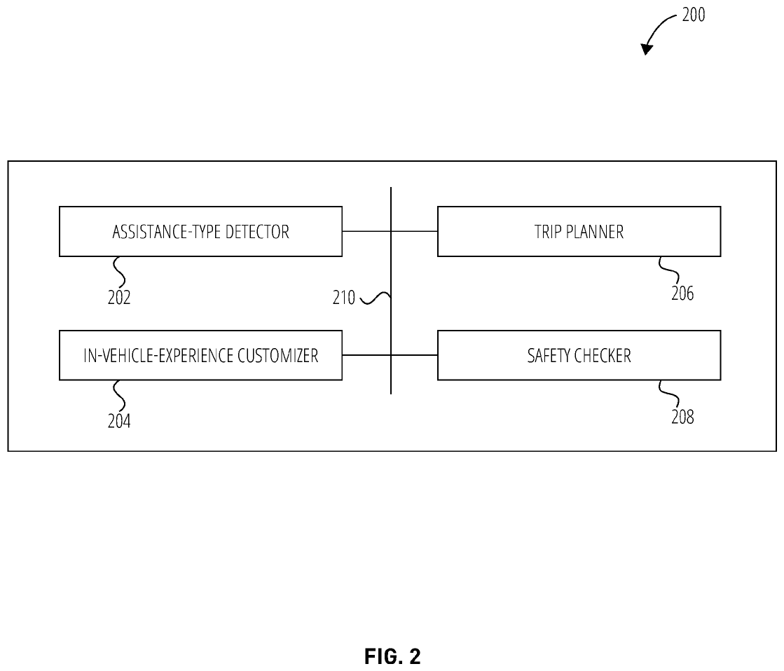

FIG. 1 depicts an example accessible-ride process flow 100, in accordance with at least one embodiment. It is noted that elements outside of the depicted dashed box 126 are referred to herein as “events,” and are not part of the accessible-ride process flow 100. Those elements that are part of the accessible-ride process flow 100 are referred to herein as “operations.” In an embodiment, the accessible-ride process flow 100 is performed by an passenger-assistance system such as the example passenger-assistance system 200 that is depicted in and described below in connection with FIG. 2.

At event 102, a passenger orders a rideshare or other on-demand ride from a service that uses autonomous vehicles. The passenger may do so using an app on their smartphone, for instance. At event 104, the autonomous vehicle has arrived at the location of the passenger, and the passenger enters the autonomous vehicle.

At operation 106, either before or after the passenger enters the autonomous vehicle, the passenger-assistance system 200 conducts what is referred to herein as a “pre-ride safety check.” This may involve assessing any hazards in the surroundings to ensure the safety of the passenger when entering the vehicle. This may also involve selecting an accessible pick-up location. In some embodiments, the pre-ride safety check includes providing the passenger with information to confirm that this is the ordered vehicle, either digitally (e.g., to the app on the smartphone), using an audible announcement, and/or in another one or more ways.

In situations in which a passenger has used their smartphone app to register their need for assistance, the autonomous vehicle may perform the following steps as at least part of the pre-ride safety check:
Based on knowing the location, direction, and travel speed of a vehicle, the autonomous vehicle may predetermine the pickup stop, the door targeted for entering the vehicle, and the arrival time. This information may be shared to with the passenger via the app prior to the arrival. The rear passenger door facing the curb may be chosen by default.
When the vehicle has arrived, it may request that the passenger that arrival via the app, for example, After confirmation, installed computer-vision cameras may be used to detect that the passenger is waiting in front of the car door and open it automatically if it detects them.
For safety reasons, the autonomous vehicle may give a warning such as turning on double signal lights when the passengers are trying to enter the vehicle.
For the benefit of many types of passengers (e.g., visually impaired passengers), a car door may be designed to be operated with voice control. Furthermore, the door may be built with sensors to detect any objects that are outside of the vehicle but sufficiently close to collide with the opened door or entering/exiting passengers. The door may be equipped to produce sounds that alert others when closing or opening.

In other situations in which a passenger has not preregistered their need for assistance (or have not done so to a certain degree of specificity, have outdated profile information, have a new need for assistance due to a recent broken leg, surgery, etc.), embodiments of the present disclosure are still able to detect this.

Additionally, in at least one embodiment, as a pre-ride check for safety inside the vehicle, thermal face-detection cameras are used to recognize live face and human physiological activities as a liveness indicator to prevent spoofing attacks. As a result, existing image-fusion technology can be applied to combine images from visual cameras and thermal cameras using techniques like feature-level fusion, decision-level fusion, or pixel/data-level fusion, and so forth, to provide more detail and reliable information.

Moreover, in some embodiments, additional safety measures are implemented such as monitoring in-vehicle activities to detect anything out of the ordinary for safety reason. For example, an alarm system, an in-vehicle video-recording system, or/and an automatic emergency (e.g., SOS) call can be triggered if there are intruders, strangers, and/or the like who are not supposed to be in the vehicles prior to the entrance of a blind passenger. Some embodiments of the present disclosure use such technology (e.g., visual and/or thermal cameras) to count the number of living beings including stray animals, so that the disabled passengers can confirm a safe environment is present in the autonomous vehicle.

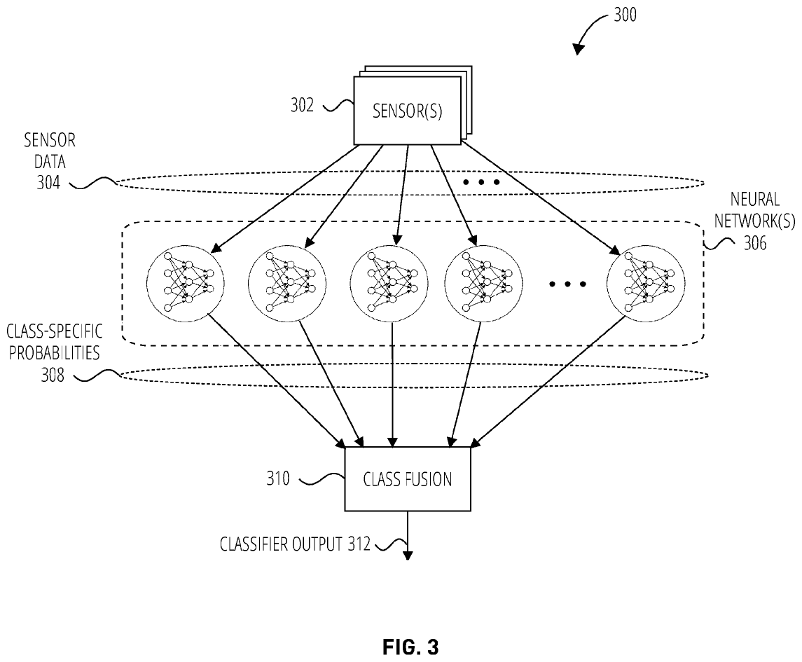

At operation 108, the passenger-assistance system 200 identifies that the passenger is an assistance passenger in that the passenger is classified by the passenger-assistance system 200 as having an assistance type from among a set of multiple assistance types. Some specifics that are implemented in at least some embodiments are discussed below in connection with FIG. 3. In some embodiments, passengers that are determined to not need assistance are referred to as having an assistance type of “none.” In other embodiments, such passengers are described as not having an associated assistance type. In any event, in at least one embodiment, the remainder of the accessible-ride process flow 100 is not executed in connection with these passengers.

The rest of this description of FIG. 1 assumes that the passenger has been identified as having an assistance type that qualifies the passenger as being an assistance passenger as that term is introduced above. As described, in at least one embodiment, the passenger-assistance system 200 obtains a passenger profile associated with the passenger, and identifies the assistance type of the passenger based at least in part on data in the passenger profile, where that data indicates the assistance type of the passenger. Such data could also or instead be provided in booking data received by the passenger-assistance system 200.

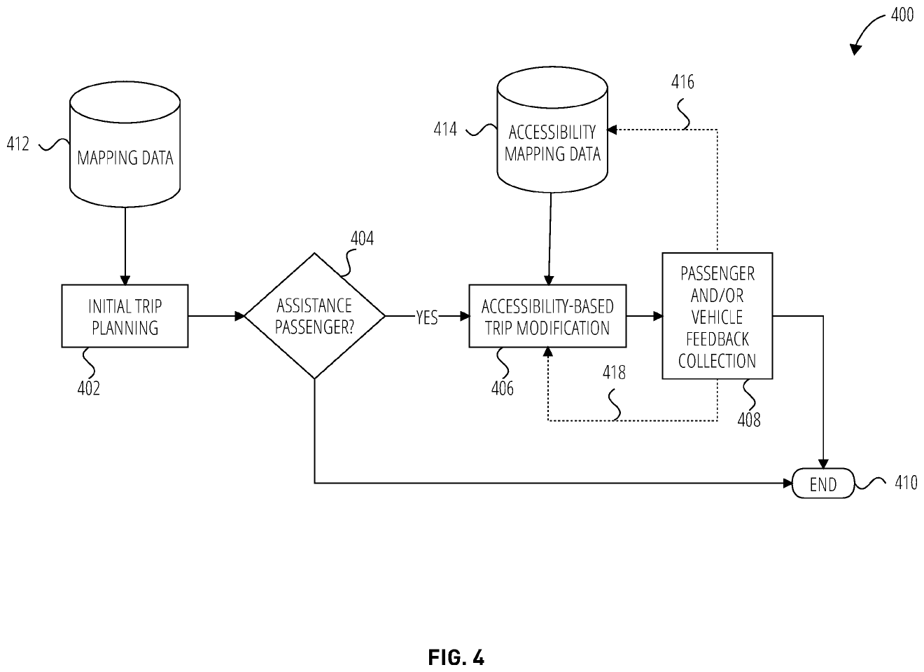

At operation 110, the passenger-assistance system 200 customizes an in-vehicle experience for the assistance passenger. Some examples of these customization functions are further described below. At operation 112, the passenger-assistance system 200 executes a trip-planning operation to plan a route for the ride requested by the assistance passenger. Examples of the trip-planning operation 112 are further described below in connection with at least FIG. 4.

At operation 114, the passenger-assistance system 200 performs a passenger-feedback-collection operation 114. As described more fully below, this may involve collecting and providing assistance-type feedback 120 to the assistance-type-detection operation 108, providing experience-customization feedback 122 to the in-vehicle-experience-customization operation 110, and/or providing trip-planning feedback 124 to the trip-planning operation 112, among other possibilities. With respect to the assistance-type feedback 120, that feedback may pertain to the accuracy of the identified assistance type of the passenger. The assistance-type operation 108 may used that feedback to modify the manner in which it conducts an identification of an assistance type of at least one subsequent passenger of the autonomous vehicle.

In the case of the experience-customization feedback 122, that feedback may represent in-vehicle-experience feedback from the passenger during at least part of the ride. The assistance-type operation 108 may use that feedback to modify the manner in which it controls one or more passenger-comfort controls (e.g., seat position, temperature, etc.) during the ride and/or with respect to subsequent passengers in subsequent rides. Regarding the trip-planning feedback 124, that feedback may pertain to the generated modified route for the ride, and the trip-planning operation 112 may use that feedback to modifying the manner in which it generates a modified route for at least one subsequent ride for at least one subsequent passenger.

At operation 116, the passenger-assistance system 200 conducts a pre-exit safety check. This may involve evaluation and reselection of a particular drop-off location. For example, high-traffic areas, no-signal intersections, and the like may be avoided. Furthermore, as an example, an audio announcement of the location may be made for a blind passenger. Dropping off passengers (e.g., in wheelchairs, on crutches, and so on) at the top of staircases may also be avoided. Hazards such as bicyclists speeding by in bike lanes may also be monitored and avoided. Audible warnings may be issued, door locks may be controlled, different drop-off locations may be selected, etc. An oncoming bicyclist could also be given a warning. Vehicle sensors may be used to identify the speed and distance of an oncoming object to calculate the chance of a collision.

Prior to exit, based on the particular assistance type of the passenger, the system may customize announcements (e.g., text for hearing-impaired passengers, audible announcements for vision-impaired passengers, and so forth) and may also confirm the passenger's destination in a similar manner. In some embodiments, object-detection cameras are employed to recognize and detect any objects that are unattended when the passenger is about to leave the vehicle (based, e.g., on the passenger's movement within the vehicle). For example, the system may check prior to unlocking the car door if the passenger forgot their crutches, cane, and/or the like. At event 118, the assistance passenger exits the autonomous vehicle.

FIG. 2 depicts an example passenger-assistance system 200, in accordance with at least one embodiment. This depiction of architecture, components, and the like of the passenger-assistance system 200 is provided by way of example, and other arrangements may be used. As shown in FIG. 2, the passenger-assistance system 200 includes an assistance-type-detection unit 202, an in-vehicle-experience-customization unit 204, a trip-planning unit 206, and a safety-check unit 208, all of which are communicatively connected with one another via a system bus 210. Other components that would typically be present (e.g., processor circuitry, memory, communication interfaces, and so on) are omitted from FIG. 2 for clarity of presentation.

In embodiments of the present disclosure, the assistance-type-detection unit (labeled “assistance-type detector in FIG. 2), the in-vehicle-experience customization unit 204 (“in-vehicle-experience customizer” in FIG. 2), the trip-planning unit 206 (“trip planner”), and a safety-check unit 208 (“safety checker”) are each implemented using what is referred to herein as a “hardware implementation.” In the present disclosure, a hardware implementation is an implementation that uses hardware, firmware-configured hardware, and/or software-configured hardware to execute logic and/or instructions to perform the herein-recited operations. A given hardware implementation could include specialized hardware, programmed hardware, logic-executed circuitry, a field programmable logic array (FPGA), and/or the like. The term hardware as used herein is a physical processor that executes logic, instructions, and/or the like. Moreover, any of the hardware implementations that are described herein can be distributed across multiple physical implementations, and multiple hardware implementations that are described separately herein can be combined in a single physical implementation.

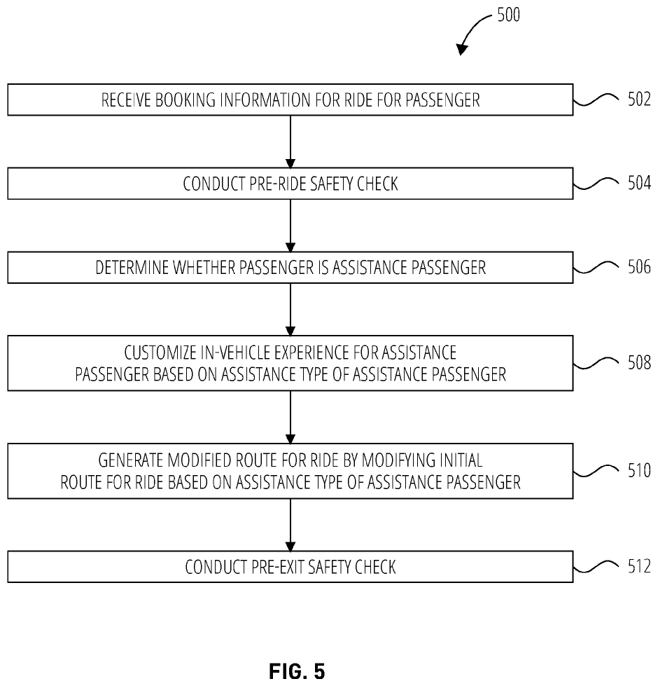

The assistance-type-detection unit 202 may perform the assistance-type-detection operation 108 described above. An example architecture of the assistance-type-detection unit 202 is described below in connection with FIG. 3. The assistance-type-detection unit 202 may also perform the operation 506 that is described below in connection with the method 500 of FIG. 5. These are examples of operations that the assistance-type-detection unit 202 may perform, not an exhaustive list. This qualifier applies to the other components of the passenger-assistance system 200 as well.

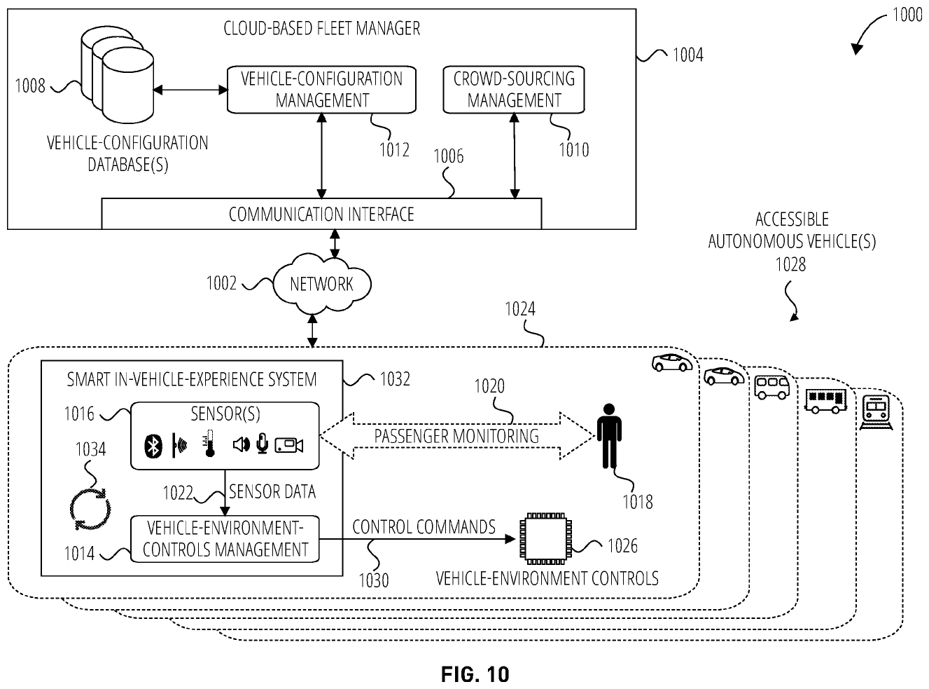

The in-vehicle-experience-customization unit 204 may perform the in-vehicle-experience-customization operation 110, the below-described operation 508, and/or the like. Moreover, the in-vehicle-experience-customization unit 204 may operate in a manner similar to that described below in connection with the example smart in-vehicle-experience system 1032 of FIG. 10. The trip-planning unit 206 may perform the trip-planning operation 112, the below-described operation 510, and/or the like. An example trip-planner process flow 400 that may be implemented by the trip-planning unit 206 is described below in connection with FIG. 4. The safety-check unit 208 may perform the pre-ride-safety-check operation 106, the pre-exit-safety-check operation 116, the operation 504 of FIG. 5, the operation 512 of FIG. 5, and/or the like.

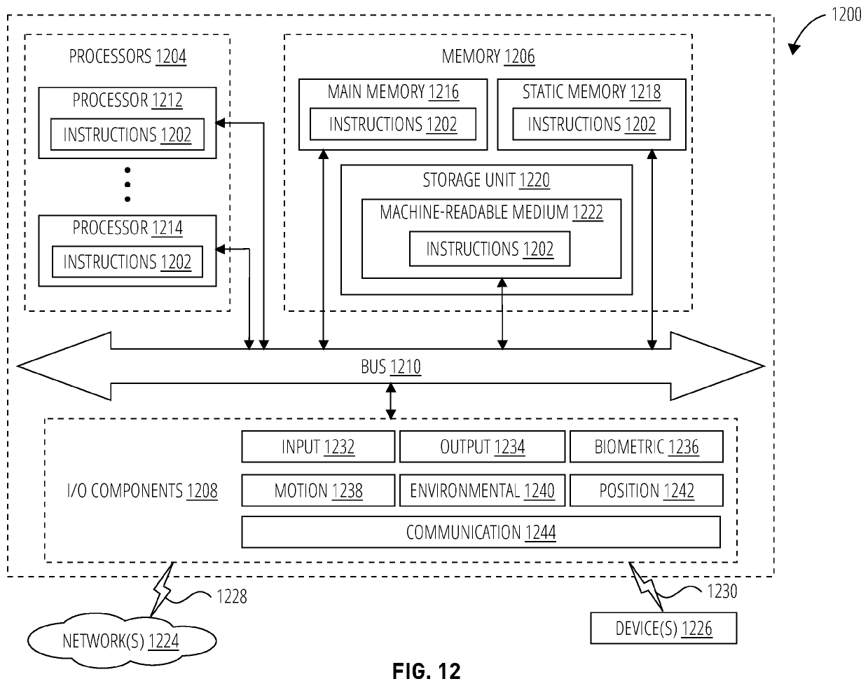

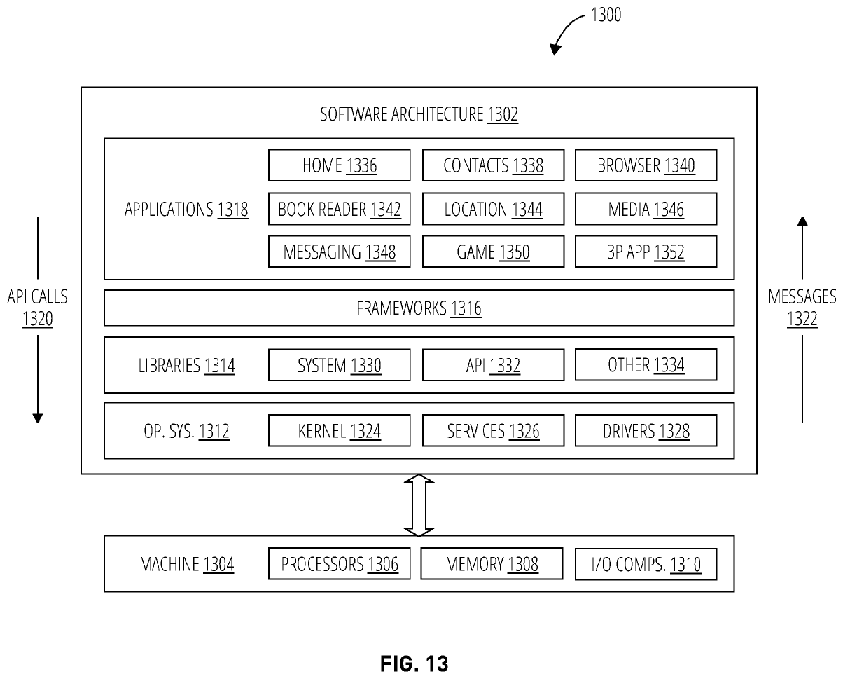

Moreover, it is noted that any device, system, and/or the like that is depicted in any of the figures may take a form similar to the example computer system 1200 that is described in connection with FIG. 12, and may have a software architecture similar to the example software architecture 1302 that is described in connection with FIG. 13. Any communication link, connection, and/or the like could include one or more wireless-communication links (e.g., Wi-Fi, Bluetooth, LTE, 5G, etc.) and/or one or more wired-communication links (e.g., Ethernet, USB, and so forth).

It is explicitly noted herein and contemplated that various embodiments of the present disclosure do not include all four of the functional components described in connection with FIG. 1 and elsewhere herein. Any subset of one or more of those four functional components (and equivalently the corresponding operations in method embodiments, instructions in CRM embodiments, etc.) is considered an embodiment of this disclosure. For example, some embodiments do not include the in-vehicle-experience customizer 204. Some embodiments do not include the safety checker 208. Some embodiments include the assistance-type detector 202 and the in-vehicle-experience customizer 204 but not the trip-planning unit 206 or the safety-check unit 208. Others include the assistance-type detector 202 and the trip-planning unit 206 but not the in-vehicle-experience customizer 204 or the safety-check unit 208. And so forth.

FIG. 3 depicts an example architecture 300 that may be implemented by the assistance-type-detection unit 202, in accordance with at least one embodiment. More generally, the architecture 300 is an example architecture that can be used in various different embodiments to identify whether a given passenger is an assistance passenger and, if so, what assistance type (or types) correspond to that assistance passenger. In situations in which multiple assistance types are identified in connection with a given assistance passenger, the in-vehicle-customization operations, the trip planning, the safety checks, and/or the like may be conducted in a manner that takes the multiple assistance types into account.

The architecture 300 includes an array of sensors 302 that gather sensor data 304 with respect to the passenger and communicate the sensor data 304 to each of a plurality of neural networks 306. The neural networks 306 are implemented using one or more “hardware implementations,” as that term is used herein. In at least one embodiment, each of the neural networks 306 outputs a set of class-specific probabilities 308 to a class-fusion unit 310. The stack of neural networks 306 may be trained to compute the class-specific probabilities 308 based on various different subsets of the sensor data 304. The subset used by each given neural network 306 may be referred to as the features of that neural network 306. In an example, class-specific probabilities 308 each relate to an assistance type from among a set of assistance types such as {blindness, deafness, physical impairment, sickness, none}. These are just examples, and numerous others could be used in addition to or instead of any of these.

The class-fusion unit 310 may identify an assistance type of a given passenger based on the class-specific probabilities 308 calculated by the neural networks 306. The class-fusion unit 310 may combine the predictions of the different individual detector components to a global result. In some embodiments, a rule-based approach is used. However, various selection algorithms can be used instead. The steps of a rule-based class-fusion selection algorithm are:
All available prediction scores for the same class from different detector components are averaged.
Class probabilities are normalized (e.g. using a SoftMax layer) and the class with the maximum score after detector fusion is selected as the most likely type.
If “None” is not an explicit class of the individual detectors, then it may be added at the fusion stage if no other prediction score exceeds a specific threshold, e.g. 0.3.
If multiple classes have scores beyond a threshold, for example >0.3, the passenger is likely to have multiple assistance types. In this case, multiple assistance functions may be triggered. If some assistance functions are incompatible or mutually exclusive, some embodiments select the disability class that requires more support. An example ranking might be: blind>handicapped>elderly>deaf>None.

In at least one embodiment, the neural networks 306 may include what is referred to herein as an assistance-request neural network configured to calculate its plurality of probabilities based at least in part on what is referred to herein as an assistance prompt subset of the sensor data. That subset may indicate a response or lack of response from the given passenger to at least one special-assistance prompt presented to the given passenger via a user interface in the autonomous vehicle. As another example, the neural networks 306 may include what is referred to herein as a sensory-reaction neural network, which may be configured to calculate its plurality of class-specific probabilities 308 based at least in part on what is referred to herein as a stimulated-response subset of the sensor data. That subset may indicate a reaction or a lack of reaction by the given passenger to one or more sensory stimuli (lights, sounds, vibrations, etc.) presented in the vicinity of the given passenger.

In some embodiments, the neural networks 306 include what is referred to herein as an age-estimation neural network. That neural network 306 may be configured to use the sensor data to calculate an estimated age of the given passenger, and then calculate its plurality of class-specific probabilities 308 based at least in part on the calculated estimated age of the given passenger. As yet another example, the neural networks 306 may include what is referred to herein as an object-detection neural network. That neural network 306 may be configured to use the sensor data to identify whether the given passenger has with them one or more assistance objects from among a plurality of assistance objects (wheelchair, cane, crutches, and so on). The neural network 306 may then calculate its plurality of class-specific probabilities 308 based at least in part on a lack of or presence of any identified assistance objects from among the plurality of assistance objects.

The multimodal sensors 302 may include but are not limited to cameras, microphones, radio sensors, infrared cameras, thermal cameras, lidar, etc. In various different embodiments, passive and/or active monitoring could be used.

The sensor data classifier output 312, which is also a hardware implementation, serves as input to a parallelized analysis process involving deep learning (DL) components that classify the person under consideration with respect to at least the following classes: “blind/visually impaired”, “deaf”, “elderly”, “physically handicapped”, or “none,” as examples. In the first stage of this analysis, multiple diverse classifiers make a class prediction with a focus on a selected subset of individual assistance types. In the second stage, those predictions are combined in a class-fusion step to identify the globally most likely assistance class. Classifier predictions can be made before or after the passenger enters the vehicle, depending on the presence or coverage of inside/outside sensors. If the assistance-type detection is performed outside of the vehicle, the process of entering the vehicle can be further facilitated, for example by opening the door more, or by enabling a ramp for wheelchairs.

For the individual neural networks 306, one or more of the following may be used:
Assistance request classifier (referred to above as an “assistance-request neural network”):
   An autonomous vehicle may offer special assistance to any passenger that enters the vehicle. This request may be presented via a recorded audio message and/or via displaying the question on a screen. The passenger may accept special assistance by giving an audio reply or by pressing an indicated button, touching the screen, etc. If this is the case, the system may assign a very low or zero probability to the predicted outcome “None” (no disability). On the other hand, if no special assistance is requested, this can still mean that the passenger failed to react to the request in time, did not hear or see the message, or decided not to communicate regarding a need for assistance. In this case, the other detector components may be used to determine if a such a need is present.
Audio/light reaction detector (referred to above as a “sensory-reaction neural network”):
   This detector component may exposes the passenger to simultaneous signals that expect a specific response. For audio, this could be for example a recorded request to answer with a specific key word. For visuals, for example, a message can appear on a screen that asks the user to press a button, to turn the head to a given direction, or similar. If those responses do not occur after a waiting time of a few seconds, the classifier may conclude that there is a high chance of the passenger being blind or deaf, respectively. This component may provide estimates for the classes “blind”, “deaf” or “None”. For this part, in some embodiments, a binary logic can be used that does not require deep learning. This component can be similar to the special assistance request but may try to identify a specific disability type rather than enquiring about a disability in general.
Age estimator (referred to above as an “age-estimation neural network”):
   In some embodiments, camera images of human faces can be used with CNN classifiers to estimate a person's age. The neural network is here trained to detect specific features such as wrinkles or hair shapes, colors, etc. This results in probabilities for specific age bins. In at least one embodiment, the system distinguishes only between elderly and non-elderly persons for this purpose, and therefore may be keyed to whether an accumulated probability p (age>threshold) exceeds a tunable threshold of for example 70 years, which may represent the class “elderly.”
Object detector (referred to above as an “object-detection neural network”):
   The component may be a CNN classifier trained to detect relevant objects (or service animals) such as crutches, wheelchairs, canes, guiding dogs, hearing aids, eye covers, or similar. In some embodiments, well-established CNN architectures for object detection are used. In some such cases, the parameters are retrained to make the network efficient in detecting the desired features. Specific datasets to identify blind or otherwise assistance people may be used. This component may provide predictions related to at least the “blind,” “elderly,” “handicapped,” or “None” class.

Moreover, given a sufficiently accurate detector, this system can be readily extended to include the detection of other special circumstances, such as for example pregnancies, reduced mobility, muteness, and/or the like.

With respect to the in-vehicle experience of the assistance passenger, it is desirable to make the passenger feel confident and comfortable that the vehicle is heading to the right destination. As an example, this can be achieved by a frequent announcement of the key landmarks along the journey, through frequent and customized vehicle-passenger interaction in the vehicle (e.g. language, sign language, etc.). Once the passenger has been identified as having a particular assistance type, in-vehicle sensors (camera, and microphone) and actuators (speaker, and seat vibrator) may be used to interact with the passenger. To provide customized vehicle-to-passenger interaction, one or more of the following devices and processes may be used:
In-vehicle camera with depth information (e.g., a depth camera) for better accuracy:
   Sign Language-use to recognize the sign language. The interactive method can be by using audio and the display (text and sign language).
   Sitting Posture-passenger seating posture is important to ensure passenger's safety if an airbag deploys during an accident. The camera can be used to recognize the passenger's unsafe seating posture (e.g. laying down, legs up, etc.), and provide a warning to the passenger, or reduce the driving speed if the passenger continues with an unsafe seating posture.
   Hand-Gesture Recognition-use to provide guidance to a blind person's hand moving toward an interactive touch screen display. This can be done by using a camera to localize the person's hand, guiding the hand movement toward the screen by using audio.
Touch screen with dynamic braille code display:
   An interactive display can be presented to the passenger for entering the destination, trip information, etc. The display may be dynamic Braille display capable. This touch screen can be used by a blind person who understands Braille. The acknowledgement of the entered information can be done by visual, audio, and/or tactile indications.
Audio interaction at the rear seat:
   The speaker and microphone can be placed at the rear seat, which is closer to passenger for better audio experience.
   Provide close audio interaction such as announcing journey information (e.g. landmark/ROI, trip duration/distance, traffic and road conditions, weather information, etc.). All of this information may increase the level of confidence for many types of passengers (e.g., visually impaired passengers, tourists, and others) with respect to reaching their expected destination.
   Speech recognition with Natural Language Processing (NLP) capable in understanding passenger intent. If a blind person does not understand Braille, he/she can use natural language calling out the destination.
Seat vibration:
   To avoid passengers missing out (e.g., falling asleep, talking on phone, etc.) on important announcements such as emergencies, approaching/arriving at destination, a seat vibration can further alert the passenger in addition to or instead of an audio announcement.
Adaptable driving speed:
   The driving speed can be customized for passengers that may feel not comfortable in driving at relatively fast speed. The vehicle can slow down the speed, e.g. 10% slower than normal driving speed if there is elderly or pregnant woman onboard, as examples.

FIG. 4 depicts an example trip-planner process flow 400, in accordance with at least one embodiment. The trip-planner process flow 400 may be executed by the trip-planning unit 206 of FIG. 2. The trip-planning unit 206 may perform an initial-trip-planning function 402 in which a trip for a requested ride for a passenger is determined using mapping data 412, which may be a standard set of mapping data that may not include accessibility information. The trip-planning unit 206 then determines, at decision block 404, whether an assistance type was detected by assistance-type-detection unit 202. If not, control proceeds to a done block 410. If so, control proceeds to an accessibility-based trip-modification function 406, according to which an initial route is modified using accessibility mapping data 414 in light of the identified assistance type. After the accessibility-based trip-modification function 406, control proceeds to a feedback-collection function 408, at which passenger feedback is collected regarding the modified route. Trip-modification feedback 418 is communicated from the feedback-collection function 408 to the accessibility-based trip-modification function 406 as a forward-feedback loop. Control then proceeds to the done block 410.

Modifying a trip route could include selecting a different drop-off location at a destination of the ride based on the identified assistance type. The accessibility mapping data 414 may include data about features such as building door types (e.g., revolving), bus lanes, bike lanes, and/or the like. Trip planning may be adapted to the needs of a disabled person, as described before. This may include appropriately accessible drop-off points (considering, e.g., ramps to enter buildings with wheelchairs instead of staircases, blind-friendly junctions, etc.). Those points can be extracted from existing accessibility databases, e.g. wheelmap and access earth. Alternatively, vehicle sensors can be leveraged to crowd-source accessibility information. Contextual sensor data can be processed to evaluate the ease of accessibility based on a target parking location of the vehicle and particular user needs.

In at least one embodiment, the following operations may be performed:
a conventional trip planning based on a standard navigation map (initial-trip-planning function 402);
Next, the assistance-type-detection unit 202 analyzes the presence and type of assistance needed for a passenger (decision block 404). If no disability is present the traditionally planned trip is executed without any modifications.
If a need for assistance is detected, the trip may be modified (accessibility-based trip-modification function 406) depending on the assistance type and on available information of additional, disability-friendly mapping data (accessibility mapping data 414). This knowledge may be obtained from existing databases and/or from vehicle crowd-sourcing. The trip-planning unit 206 calculates adjustments to determine an acceptable route for an individual disabled passenger.
The trip-planning unit 206 can be implemented in a manner that includes execution on hardware of a deep-learning neural network that is trained to map the combined input of (starting point, destination, map, disability-friendly map, disability type) to an optimal route. The maps and the route solution can in this case be represented by a set of discrete way points.

After the ride, the feedback system from the autonomous vehicle may be able to collect the passenger's preference during a pre-exit experience survey. This information may be used to augment or update the accessibility mapping data 414 for future trip planning. Furthermore, embodiments incorporate the feedback to update/retrain the accessibility-based trip-modification function 406 at regular intervals. For example, the accessibility-based trip-modification function 406 may learn over time which drop-off points passengers with a particular type of disability prefer. For example, a person with a wheelchair might find Door A of a shopping mall preferable as there is a ramp and a security guard who can assist him/her to push the door open. A blind person might find Door B more appropriate as there is a speaker there which broadcasts announcements, which will assist him/her to find the right direction.

Furthermore, feedback can also be extracted from the external vehicle sensors of the autonomous vehicle. The sensors can verify the existence of ramps or other elements and/or could track the passenger's movement after exiting (distance/time to reach the door of the mall) to update the accessibility mapping data 414 for preferred drop-off point. The matching of the type of disability and the preferred drop-off location will provide valuable information and feedback to the cloud for an updated accessibility map and a robust trip planner. This will continuously improve the passenger experience.

FIG. 5 depicts an example method 500, in accordance with at least one embodiment. By way of example and not limitation, the method 500 is described here as being performed by the passenger-assistance system 200 of FIG. 2. At operation 502, the passenger-assistance system 200 receives booking information for a ride for a passenger of an autonomous vehicle. At operation 504, the passenger-assistance system 200 conducts a pre-ride safety check for the ride based at least on the booking information. At operation 506, the passenger-assistance system 200 determines that the passenger is an assistance passenger of at least one identified assistance type from among a plurality of assistance types. At operation 508, the passenger-assistance system 200 customizes an in-vehicle experience for the assistance passenger, including controlling one or more passenger-comfort controls of the autonomous vehicle based on the at least one identified assistance type. At operation 510, the passenger-assistance system 200 generates a modified route for the ride at least in part by modifying an initial route for the ride based on the at least one identified assistance type. At operation 512, the passenger-assistance system 200 conducts a pre-exit safety check based on the at least one identified assistance type.

In at least one embodiment, the passenger-assistance system 200 also collects in-vehicle-experience feedback from the assistance passenger during at least part of the ride, and modifies the controlling of the one or more passenger-comfort controls based on that collected in-vehicle-experience feedback. Moreover, in at least one embodiment, the passenger-assistance system 200 performs the operation 506 at least in part by using a sensor array that includes at least one sensor to collect sensor data with respect to the assistance passenger. The passenger-assistance system 200 also uses a plurality of neural networks to calculate, based on the sensor data, a plurality of probabilities that each correspond to the given passenger having a different particular assistance type in a plurality of assistance types. Furthermore, the passenger-assistance system 200 identifies the at least one identified assistance type of the assistance passenger based on the probabilities calculated by the neural networks in the plurality of neural networks.

Embodiments of the present disclosure address the issue that, too often, assistance passengers avoid public transportation due to the physical barriers and safety concerns. This is even more common in cases in which, for example, visually-impaired assistance passengers are not familiar with the route and if information on the vehicle is only available in a certain format (e.g., display only or announcement only), generally meaning that they will seek assistance from fellow travelers and/or the driver. Some example hurdles faced by these assistance passengers include:
anxiety about taking public transportation alone;
not exiting the bus at the correct destination;
getting hurt due to a bus suddenly stopping, accelerating, etc.;
being reluctant to seek help from fellow passengers;
often feeling that they want or need to avoid traveling during non-traditional business hours due to a frequent lack of assistance at those times;
having difficulty identifying proximity to a given landmark;
having difficulty hearing announcements due to ambient noise in and around the vehicle; and
having announcements and displays be limited to the most common language in a given locale.

These hurdles may be exacerbated with the deployment of autonomous vehicles.

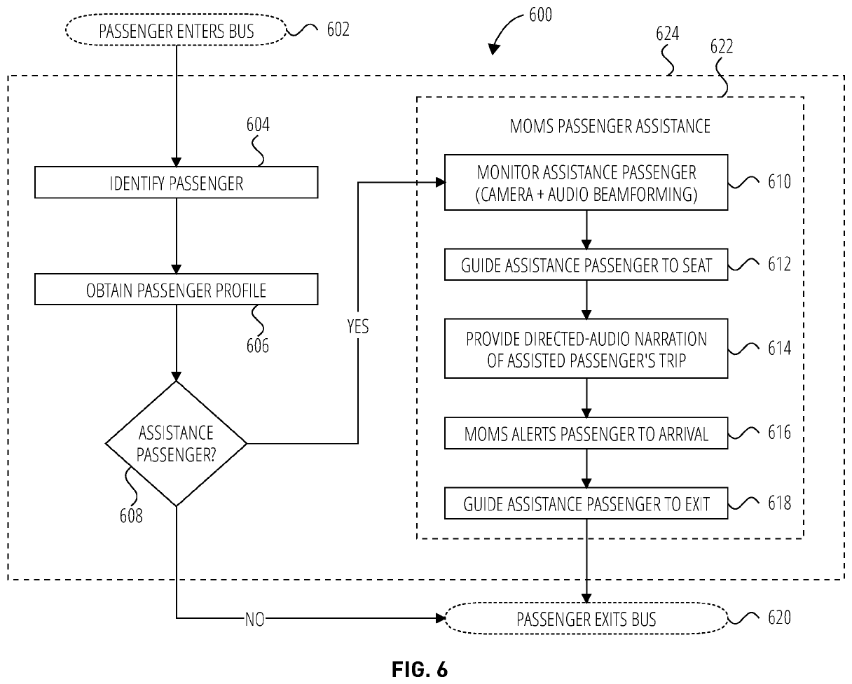

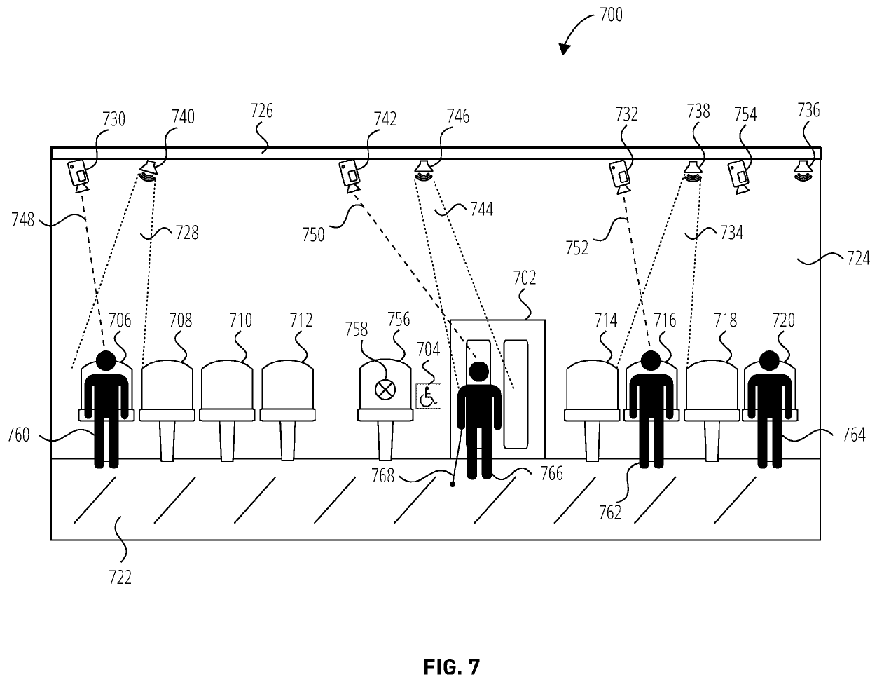

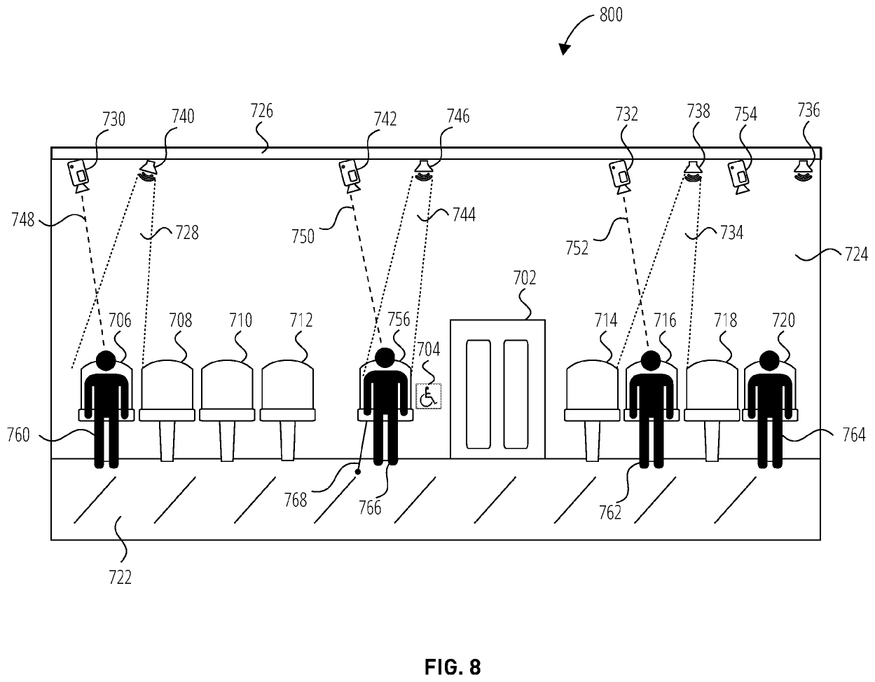

FIG. 6 depicts an example multi-passenger-vehicle process flow 600, in accordance with at least one embodiment. By way of example and not limitation, the multi-passenger-vehicle process flow 600 is described here as being performed by a multi-passenger accessible autonomous vehicle (e.g., a bus). Furthermore, the multi-passenger-vehicle process flow 600 is described here with reference to a first accessible-vehicle scenario 700 that is depicted in FIG. 7 and a second accessible-vehicle scenario 800 that is depicted in FIG. 8. Similar to the terminology used above in the description of FIG. 1, the elements in FIG. 6 that are part of the multi-passenger-vehicle process flow 600 are shown inside the dashed box 624 and are referred to as “operations,” whereas the elements that are not part of the multi-passenger-vehicle process flow 600 are described as “events.”

As shown in FIG. 7, the accessible-vehicle scenario 700 depicts part of an example interior of a multi-passenger accessible autonomous vehicle (e.g., bus). There is a door 702, a walkway 722, a wall 724, seats 706, 708, 710, 712, 714, 716, 718, 720, and 756. The seat 756 includes a tactile-alert element 758. Depicted as currently being on the bus are passengers 760, 762, and 764, as well as an assistance passenger 766. In this example, the assistance passenger 766 is a blind person and is carrying a cane 768. Mounted on a ceiling 726 are cameras 730, 732, 736, and 742, as well as speakers 736, 738, 740, and 746.

In the accessible-vehicle scenario 700 that is depicted in FIG. 7, the passenger 760 is in the line-of-sight 748 of the camera 730 and is in the path of an audio beam 728 from the speaker 740. The passenger 762 is in the line-of-sight 752 of the camera 732 and is in the path of an audio beam 734 from the speaker 738. Furthermore, the assistance passenger 766, who has just entered via the door 702, is in the line-of-sight 750 of the camera 742 and is in the path of an audio beam 744 from the speaker 746.

At event 602, the assistance passenger 766 enters the autonomous bus. At operation 604, the multi-passenger accessible autonomous vehicle obtains a passenger profile for the assistance passenger 766. At decision block 608, the multi-passenger accessible autonomous vehicle determines whether the passenger is an assistance passenger. If not, the multi-passenger-vehicle process flow 600 is terminated with respect to that particular passenger, who would eventually exit the bus at event 620.

When, however, the passenger is an assistance passenger, a MOMS-personal-assistance operation 622 is performed by a MOMS onboard the multi-passenger accessible autonomous vehicle. The MOMS-personal-assistance operation 622 is a set of operations to assist the assistance passenger 766. At operation 610, the MOMS is triggered to monitor the assistance passenger 766 using, in this case, the camera 742 and the audio beam 744 from the speaker 746.

At operation 612, the MOMS uses the audio beam 744 to guide the assistance passenger 766 to the seat 756, which is an accessible seat. The result of operation 612 is shown as the accessible-vehicle scenario 800 of FIG. 8. It is noted that, in FIG. 8, the assistance passenger 766 is in the seat 756 and is still in the now-moved line-of-sight 750 of the camera 742, and is still receiving the now-moved audio beam 744 from the speaker 746.

At operation 614, during the time in which the assistance passenger 766 is on the bus, the MOMS provides directed-audio narration (e.g., landmarks, distance to destination, number of stops to destination, etc.) of the passenger's trip. At operation 616, the MOMS alerts the assistance passenger 766 to the arrival (and/or imminent arrival) of the bus at the passenger's destination. This alert may be provided via the audio beam 744 and/or the tactile-alert element 758 (which may vibrate, pulse, and/or the like), as examples. At operation 618, the MOMS uses the camera 742 and the audio beam 744 to guide the assistance passenger 766 back to the door 702, so that the assistance passenger 766 may safely exit the bus as shown at event 620.

The directed audio beamforming is localized to the assistance passenger 766 and provides reduced ambient noise and increased audio amplification. This helps to provide clear 1:1 assistance to the assistance passenger 766. This technique can be applied to multiple different passengers with different personally localized audio beams as shown in FIG. 7 and FIG. 8.

Some aspects of embodiments of the present disclosure include:
Using cameras to identify and track the dynamic passengers that need help. The passengers can pre-alert their need through the profile of the ride hailing software apps that support the feature. Or the information can be retrieved from ticket\e-ticket (depending on the public transport ticketing system), where they are typically sold with discounted price for disabled, elderly, and young travelers.
Using audio beamforming techniques to guide the assistance passengers without being audible to others passenger. For example, voice-guided announcements can be used to help the assistance passengers be seated in dedicated areas & seats, reminding them to put on seat belts, and so on.
Using audio beamforming techniques with amplified audio to direct preselected and defined announcements specifically to individual assistance passengers.
Using other devices like the tactile-alert element 758 to help alert the passenger to their destination approaching or any emergency.
Using cameras to identify whether passengers need to have an announcement repeated, in some embodiments by detecting a gesture such as a raising a hand.
Providing one-to-one auditory guidance to individual passengers.
Providing a new type of experience to assistance passengers, to help them gain confidence in traveling alone to unfamiliar destinations.
Providing personalized guidance to tourists in their preferred language without disturbing others.

Some examples of use cases include:
Blind Passengers
   When a blind passenger gets on the bus and provides their profile either through their ticket, eticket, mobile apps, and/or the like, the system can identify the blindness of the passenger having by scanning the passenger profile. Then the MOMS can be triggered, and the camera may start acquiring the passenger location while the audio beamforming may start to provide guidance to the specific passenger to be seated in the dedicated priority seat.
   The MOMS may continuously monitor and announce landmarks, distance to destination, and the like. The audio beamform with amplified audio gain and reduced noise helps the passenger hear the guidance announcement clearly and without distracting other passengers. Once the bus arrives a the passenger's destination, the seat vibration may be provided to alert the passenger. The similar guidance may be provided to the customer to guide them to safely exit the vehicle once they arrive at the destination.
Hearing-Impaired Passengers
   Embodiments of the present disclosure are helpful for hearing-impaired passengers, as the audio beamforming makes the guidance announcement louder (for example. a 2 dB gain in audio) to the specific hearing-impaired passenger as compared to typical audio announcements. Therefore, even hearing-impaired person can hear clearly the guidance on the arrival location when they need assistance.
Tourists
   Tourist profiles can be identified from the eticket/ticket/mobile apps present when using the public transportation. Their preferred language will be identified, and the guidance can be in the language understandable by the tourist. The same style guidance can be provided for the tourist to be seated and exit the vehicle with the help of audio beamforming with camera tracking association.

To improve camera tracking efficiency, embodiments of the present disclosure use multiple cameras (e.g., a camera network) to track a person real time, which poses some challenges due to different camera perspectives, illumination changes, and pose variations. However, many of the challenges have been resolved, and there are several algorithms are available. Multiple cameras may be installed in-vehicle for object detection (human), facial recognition, and localization. These cameras can be installed at multiple areas on the ceiling of the vehicle to avoid any blind spots. Also, multiple speakers can be installed near the top of the inside of the vehicle to achieve audio beamforming.

A passenger profile can be obtained in various ways, depending on the ticketing/booking system of the autonomous vehicle. The passenger information such as type of disability (e.g. blind, hearing-impaired, etc), age, preferred language (announcements to tourists can be personalized in the language of their choosing), type of passenger (e.g. tourist, local, etc.) can be pre-registered in the system or during purchasing of an e-ticket. This information can then be communicated to the autonomous vehicle when the passenger is boarding. From the profile, the MOMS may take action to assist the passenger who requires special attention via moving auditory guidance.

With respect to assisting passengers in being seated, this involves coordination between cameras and the speakers:
Cameras may be used to locate the static/dynamic passenger via deep learning object detection and facial recognition. Once the cameras have located this passenger, they can transmit the 3D coordinates to the speakers module.
The speakers module can then use the 3D coordinate provided by the camera module to propagate the directionally focused audio to the targeted passenger via audio beamforming techniques. Audio beamforming from multiple speakers tends to attenuate surrounding noises and amplify the audio directed to the targeted passenger. With this, only the passenger who is being beamed with the audio will typically be able to hear the specific audio. The speaker system can be simultaneously beaming different audio (speech) to different passengers simultaneously.

Once the audio beamforming is locked to the targeted passenger, it can provide spoken guidance to the passenger, and provide directional instruction to a moving passenger to guide them to a priority seat. This is helpful for blind passengers who board public transportation. The MOMS can guide this passenger to the priority seat without other passenger hearing the guidance. Personalized audible announcements can be provided to multiple passengers simultaneously based on their profile, without being audible to other passengers. The personalize announcements can relate to landmarks for a blind person or tourist, as examples, and can be in a passenger-preferred language. The audio gain level of the announcements may be adjusted according to the passenger age and hearing-impairment level, as example factors.

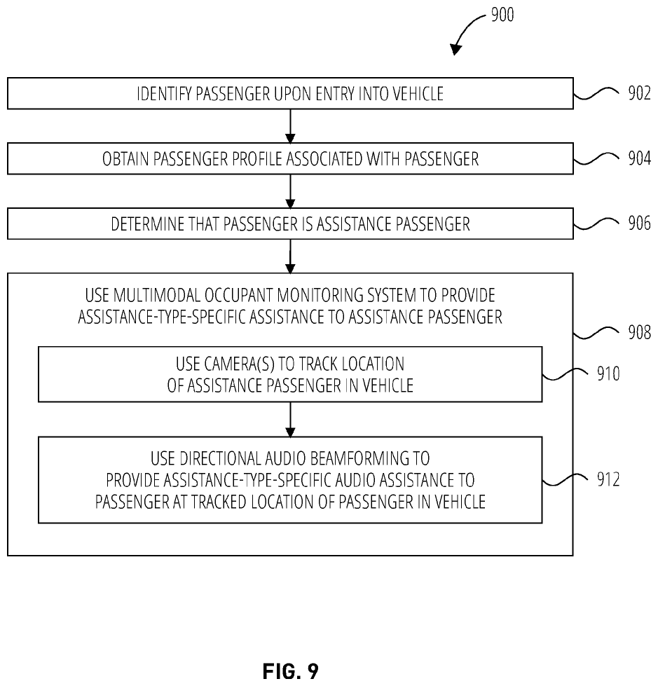

FIG. 9 depicts an example method 900, in accordance with at least one embodiment. By way of example and not limitation, the method 900 is described here as being performed by a multi-passenger accessible autonomous vehicle (e.g., a bus). The method 900 could be performed by a particular subsystem of the bus. At operation 902, the multi-passenger accessible autonomous vehicle identifies a passenger upon entry into the vehicle. At operation 904, the multi-passenger accessible autonomous vehicle obtains a passenger profile associated with the passenger. At operation 906, the multi-passenger accessible autonomous vehicle determines that the passenger is an assistance passenger.

At operation 908, the multi-passenger accessible autonomous vehicle uses a multimodal occupant monitoring system to provide assistance-type-specific assistance to the assistance passenger. At operation 910, the multi-passenger accessible autonomous vehicle uses one or more cameras to track the location of the assistance passenger in the vehicle. At operation 912, the multi-passenger accessible autonomous vehicle uses directional audio beamforming to provide passenger-specific audio assistance to the assistance passenger at the tracked location of the passenger in the vehicle.

FIG. 10 depicts an example architecture diagram 1000, in accordance with at least one embodiment. The architecture diagram 1000 shows an example architecture that could be used both within particular vehicles and among multiple vehicles as coordinated by a cloud-based system. FIG. 10 shows a number of accessible autonomous vehicles 1028 of various types (cars, shuttle buses, buses, trains, etc), though they could be of the same type. The example accessible autonomous vehicle 1024 among this group is a on-demand-ride (e.g., rideshare) vehicle in this embodiment.

The accessible autonomous vehicle 1024 currently has a passenger 1018, who in this example is an assistance passenger. Passenger monitoring 1020 of the passenger 1018 is conducted using an array of sensors 1016, which is one component of a depicted smart in-vehicle-experience system 1032, which is a hardware implementation as that term is used herein. Also depicted in the smart in-vehicle-experience system 1032 is a vehicle-environment-controls-management unit 1014, which receives sensor data 1022 from the sensors 1016 and transmits control commands 1030 to vehicle-environment controls 1026 of the accessible autonomous vehicle 1024. As depicted at 1034, the smart in-vehicle-experience system 1032 uses reinforcement learning to improve the in-vehicle experience of passengers over time based on a forward-feedback loop.

Each of the accessible autonomous vehicles 1028 is depicted as being in communication with a network 1002, as is a cloud-based fleet manager 1004. The cloud-based fleet manager 1004 is depicted as including a communication interface 1006, one or more vehicle-configuration databases 1008, a vehicle-configuration management unit 1012, and a crowd-sourcing management unit 1010. These are examples of components that could be present in a cloud-based fleet manager 1004 (which is also a hardware implementation) in various different embodiments, and various other components could be present in addition to or instead of one or more of those shown.

In an embodiment, an assistance-type-detection unit 202 of the accessible autonomous vehicle 1024 identifies the assistance type of a given passenger of the autonomous vehicle to be that the given passenger is an infant. In such an embodiment, the smart in-vehicle-experience system 1032 uses reinforcement learning and analysis of non-verbal indications of a comfort level of the infant in controlling one or more passenger-comfort controls with respect to the comfort level of the infant. In at least one embodiment, the smart in-vehicle-experience system 1032 also uses, in controlling one or more passenger-comfort controls with respect to the comfort level of the infant, aggregated infant-comfort-related data from the cloud-based fleet manager 1004 of the accessible autonomous vehicles 1028, which includes the accessible autonomous vehicle 1024.

The control command 1030 may be used for any type of comfort adjustments, including seat position, temperature, and/or any others. In an embodiment, the smart in-vehicle-experience system 1032 monitors the state and the comfort and/or stress level of a child passenger using multimodal sensor inputs (e.g., the sensors 1016), and adjust vehicle controls and configurations (e.g., driving style, suspension control, ambient light, background audio) to increase the comfort level of the child or other passenger.

Child passengers are typically unable to verbally express their needs. Accordingly, embodiments of the present disclosure monitor aspects such as a stress level of the child, a comfort level of the child, actions of the child, and so forth. Some example adjustments that can be made include:
adjusting driving style (e.g., more conservative);
adjusting driving route (e.g., to make lights, take highways, and so on to make it more likely that a child falls and/or stays asleep); and
adjusting mechanical systems of the vehicle (e.g., making the suspension more gentle).

Embodiments of the present disclosure leverage a specifically designed multimodal monitoring system for child-passengers, a local vehicle control and configuration system using reinforcement learning (RL), as well as a crowdsourcing solution to enhance the comfort for child-passengers riding in an accessible autonomous vehicle.

Embodiments use a specifically designed multimodal monitoring system that learns to detect the state of a child and the comfort/stress level the child has in the detected state, which takes various important factors into consideration that are special for child-passengers compared to adult-passengers. Those factors include, but are not limited to, the special states of a child and the special behaviors a child may have in those states (e.g., being hungry, sleepy, wet, fussing, crying, etc.), special actions a child may be involved in (e.g., being fed), the time of the day that may influence the child's state and behavior (inputs from the parents, who may have learned some schedule pattern a child may have). Moreover, considering both data from the sensors, as well as real-time feedback and inputs from the accompanying adult can help improve the success rate, because in some cases, the accompanying adult may be better at assessing the state of the child, and in others, a learned monitoring system may provide better results. An effective information exchange between the monitoring system and the accompanying adult is an important part to consider.

Some embodiments include a local vehicle control and configuration fine-tuning system using reinforcement learning, that considers both inputs from the accompanying adult and from the passenger monitoring system's outputs when determining the rewards in the RL framework. It also considers various constraints (based on prior knowledge) that limit the exploration space and avoid unsafe and known uncomfortable settings. Moreover, some embodiments employ a crowd-sourcing approach that leverages the advantages of robotaxi fleets driving through the same routes many times with many passengers.

Embodiments of the present disclosure include a novel system that 1) uses various sensor modalities, which include camera, radar, thermal, audio, inputs from the accompanying adult, to monitor a child's state and the comfort/stress level, 2) based on which the vehicle control and configuration is fine-tuned to achieve the optimal comfort for the child passenger. 3) This fine-tuning can be complemented by collecting data from multiple identical robotaxis driving on the same routes. Some components of embodiments of the present disclosure include a multimodal child-passenger monitoring system, a vehicle control and configuration system, and a cloud-based fleet manager that manages the crowd-sourcing solution.

The cloud-based fleet manager 1004 may manage service subscriptions, the crowd-sourcing of the relevant data, generate and store learned baseline vehicle configurations for different route segments. Those baseline configurations can be used by the robotaxis without the local learning capabilities, or be used as the starting configuration based on which the local learning system is further adapting to the child passenger on-board.

Some aspects of the present disclosure pertain to systems and methods for enabling safe usage of autonomous on-demand-ride vehicles by disabled passengers. Other aspects of the present disclosure pertain to systems and methods for using a multimodal occupant monitoring system (OMS) (MOMS) to provide personal assistance to passengers in multi-passenger (e.g., public-transportation) vehicles. Still other aspects of the present disclosure pertain to systems and methods for customizing and optimizing in-vehicle experiences for child passengers (of, e.g., autonomous on-demand-ride vehicles). Some additional examples of embodiments of the present disclosure are listed below:
A specifically designed child-passenger monitoring system that:
   leverages multimodal sensory inputs, including camera (e.g., for state and behavior detection), radar and thermal (e.g., for breathing pattern, PPG, heart rate detection), audio (e.g., for crying pattern detection and some other audio cues) as well as direct feedback and inputs from the accompanying adult (e.g., “expert” judgement of certain state of the child, such as hungry, sleepy) through an effective user interface (e.g., speech-based).
   detects the child's state or action (e.g., crying), the cause of the state (e.g., sleepy), and the stress level. Different combinations of those factors may lead to different vehicle control and configuration adaptation strategies that could help comfort the child.
   continuously learns and improves using new inputs from the accompanying adults and crowd-sourced data from other robotaxis with similar child-passengers.
A vehicle control and configuration system that communicates with the cloud-based fleet manager 1004 to:
   retrieve starting parameters based on the profile of the child, which can be learned from crowd-sourced data for the same road section, or learned from previous rides with the same child on the same route, or provided by the parents as part of the child's profile. Those parameters may include recommended vehicle controls such as driving style and suspension control, configuration parameters such as ambient light control (shades and in-vehicle lighting) and preferred background audios in various states, among others.
   upload relevant data to help generate or improve the crowd-sourced baseline parameters and models, or the specific models for a particular child passenger. Those data may include all the sensor data, inputs from the accompany adult, detection results, learned and applied vehicle controls and configurations, etc.
   use reinforcement-learning techniques to determine and adjust the vehicle control and configuration parameters in real-time to optimize the comfort for the child passenger, where the outputs of the passenger monitoring system, as well as inputs from the accompanying adult (which can be used to confirm or override the detected state and comfort level) are used in the reinforcement learning framework. Other constraints (based on prior knowledge) can also be introduced to limit the exploration space and avoid unsafe and known uncomfortable settings.

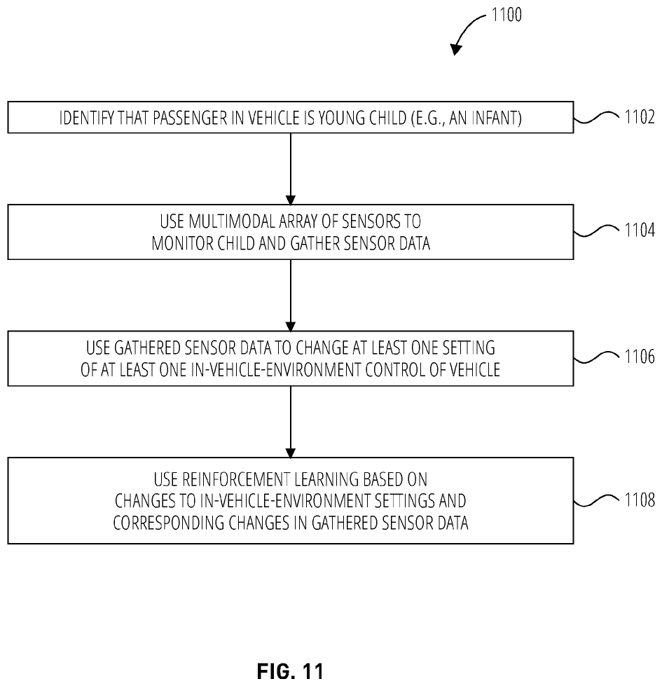

FIG. 11 depicts an example method 1100, in accordance with at least one embodiment. By way of example and not limitation, the method 1100 is described here as being performed by the smart in-vehicle-experience system 1032 of FIG. 10. At operation 1102, the smart in-vehicle-experience system 1032 identifies passenger in vehicle as being a young child (e.g., an infant). At operation 1104, the smart in-vehicle-experience system 1032 uses a multimodal array of sensors to monitor the child and gather sensor data. At operation 1106, the smart in-vehicle-experience system 1032 uses the gathered sensor data to change at least one setting of at least one in-vehicle-environment control of the vehicle. At operation 1108, the smart in-vehicle-experience system 1032 uses reinforcement learning based on changes to in-vehicle-environment settings and corresponding changes in gathered sensor data. In some embodiments, the smart in-vehicle-experience system 1032 uses an optimizing function to balance competing and/or just different objectives in the case of multiple assistance passengers in a given vehicle at the same time.

FIG. 12 illustrates an example computer system 1200 within which instructions 1202 (e.g., software, firmware, a program, an application, an applet, an app, a script, a macro, and/or other executable code) for causing the computer system 1200 to perform any one or more of the methodologies discussed herein may be executed. In at least one embodiment, execution of the instructions 1202 causes the computer system 1200 to perform one or more of the methods described herein. In at least one embodiment, the instructions 1202 transform a general, non-programmed computer system into a particular computer system 1200 programmed to carry out the described and illustrated functions. The computer system 1200 may operate as a standalone device or may be coupled (e.g., networked) to and/or with one or more other devices, machines, systems, and/or the like. In a networked deployment, the computer system 1200 may operate in the capacity of a server and/or a client in one or more server-client relationships, and/or as one or more peers in a peer-to-peer (or distributed) network environment.

The computer system 1200 may be or include, but is not limited to, one or more of each of the following: a server computer or device, a client computer or device, a personal computer (PC), a tablet, a laptop, a netbook, a set-top box (STB), a personal digital assistant (PDA), an entertainment media system, a cellular telephone, a smartphone, a mobile device, a wearable (e.g., a smartwatch), a smart-home device (e.g., a smart appliance), another smart device (e.g., an Internet of Things (IoT) device), a web appliance, a network router, a network switch, a network bridge, and/or any other machine capable of executing the instructions 1202, sequentially or otherwise, that specify actions to be taken by the computer system 1200. And while only a single computer system 1200 is illustrated, there could just as well be a collection of computer systems that individually or jointly execute the instructions 1202 to perform any one or more of the methodologies discussed herein.

As depicted in FIG. 12, the computer system 1200 may include processors 1204, memory 1206, and I/O components 1208, which may be configured to communicate with each other via a bus 1210. In an example embodiment, the processors 1204 (e.g., a central processing unit (CPU), a Reduced Instruction Set Computing (RISC) processor, a Complex Instruction Set Computing (CISC) processor, a graphics processing unit (GPU), a digital signal processor (DSP), an application-specific integrated circuit (ASIC), a radio-frequency integrated circuit (RFIC), another processor, and/or any suitable combination thereof) may include, as examples, a processor 1212 and a processor 1214 that execute the instructions 1202. The term “processor” is intended to include multi-core processors that may include two or more independent processors (sometimes referred to as “cores”) that may execute instructions contemporaneously. Although FIG. 12 shows multiple processors 1204, the computer system 1200 may include a single processor with a single core, a single processor with multiple cores (e.g., a multi-core processor), multiple processors with a single core, multiple processors with multiples cores, or any combination thereof.

The memory 1206, as depicted in FIG. 12, includes a main memory 1216, a static memory 1218, and a storage unit 1220, each of which is accessible to the processors 1204 via the bus 1210. The memory 1206, the static memory 1218, and/or the storage unit 1220 may store the instructions 1202 executable for performing any one or more of the methodologies or functions described herein. The instructions 1202 may also or instead reside completely or partially within the main memory 1216, within the static memory 1218, within machine-readable medium 1222 within the storage unit 1220, within at least one of the processors 1204 (e.g., within a cache memory of a given one of the processors 1204), and/or any suitable combination thereof, during execution thereof by the computer system 1200. In at least one embodiment, the machine-readable medium 1222 includes one or more non-transitory computer-readable storage media.

Furthermore, also as depicted in FIG. 12, I/O components 1208 may include a wide variety of components to receive input, produce and/or provide output, transmit information, exchange information, capture measurements, and/or the like. The specific I/O components 1208 that are included in a particular instance of the computer system 1200 will depend on the type of machine. For example, portable machines such as mobile phones may include a touch input device or other such input mechanisms, while a headless server machine may not include such a touch input device. Moreover, the I/O components 1208 may include many other components that are not shown in FIG. 12.

In various example embodiments, the I/O components 1208 may include input components 1232 and output components 1234. The input components 1232 may include alphanumeric input components (e.g., a keyboard, a touchscreen configured to receive alphanumeric input, a photo-optical keyboard, and/or other alphanumeric input components), pointing-based input components (e.g., a mouse, a touchpad, a trackball, a joystick, a motion sensor, and/or one or more other pointing-based input components), tactile input components (e.g., a physical button, a touchscreen that is responsive to location and/or force of touches or touch gestures, and/or one or more other tactile input components), audio input components (e.g., a microphone), and/or the like. The output components 1234 may include visual components (e.g., a display such as a plasma display panel (PDP), a light emitting diode (LED) display, a liquid crystal display (LCD), a projector, and/or a cathode ray tube (CRT)), acoustic components (e.g., speakers), haptic components (e.g., a vibratory motor, resistance mechanisms), other signal generators, and so forth.

In further example embodiments, the I/O components 1208 may include, as examples, biometric components 1236, motion components 1238, environmental components 1240, and/or position components 1242, among a wide array of possible components. As examples, the biometric components 1236 may include components to detect expressions (e.g., hand expressions, facial expressions, vocal expressions, body gestures, eye tracking, and/or the like), measure biosignals (e.g., blood pressure, heart rate, body temperature, perspiration, brain waves, and/or the like), identify a person (by way of, e.g., voice identification, retinal identification, facial identification, fingerprint identification, electroencephalogram-based identification and/or the like), etc. The motion components 1238 may include acceleration-sensing components (e.g., an accelerometer), gravitation-sensing components, rotation-sensing components (e.g., a gyroscope), and/or the like.

The environmental components 1240 may include, as examples, illumination-sensing components (e.g., a photometer), temperature-sensing components (e.g., one or more thermometers), humidity-sensing components, pressure-sensing components (e.g., a barometer), acoustic-sensing components (e.g., one or more microphones), proximity-sensing components (e.g., infrared sensors, millimeter-(mm)-wave radar) to detect nearby objects), gas-sensing components (e.g., gas-detection sensors to detect concentrations of hazardous gases for safety and/or to measure pollutants in the atmosphere), and/or other components that may provide indications, measurements, signals, and/or the like that correspond to a surrounding physical environment. The position components 1242 may include location-sensing components (e.g., a Global Navigation Satellite System (GNSS) receiver such as a Global Positioning System (GPS) receiver), altitude-sensing components (e.g., altimeters and/or barometers that detect air pressure from which altitude may be derived), orientation-sensing components (e.g., magnetometers), and/or the like.

Communication may be implemented using a wide variety of technologies. The I/O components 1208 may further include communication components 1244 operable to communicatively couple the computer system 1200 to one or more networks 1224 and/or one or more devices 1226 via a coupling 1228 and/or a coupling 1230, respectively. For example, the communication components 1244 may include a network-interface component or another suitable device to interface with a given network 1224. In further examples, the communication components 1244 may include wired-communication components, wireless-communication components, cellular-communication components, Near Field Communication (NFC) components, Bluetooth (e.g., Bluetooth Low Energy) components, Wi-Fi components, and/or other communication components to provide communication via one or more other modalities. The devices 1226 may include one or more other machines and/or any of a wide variety of peripheral devices (e.g., a peripheral device coupled via a universal serial bus (USB) connection).

Moreover, the communication components 1244 may detect identifiers or include components operable to detect identifiers. For example, the communication components 1244 may include radio frequency identification (RFID) tag reader components, NFC-smart-tag detection components, optical-reader components (e.g., an optical sensor to detect one-dimensional bar codes such as Universal Product Code (UPC) bar codes, multi-dimensional bar codes such as Quick Response (QR) codes, Aztec codes, Data Matrix, Dataglyph, MaxiCode, PDF417, Ultra Code, UCC RSS-2D bar codes, and/or other optical codes), and/or acoustic-detection components (e.g., microphones to identify tagged audio signals). In addition, a variety of information may be derived via the communication components 1244, such as location via IP geolocation, location via Wi-Fi signal triangulation, location via detecting an NFC beacon signal that may indicate a particular location, and/or the like.

One or more of the various memories (e.g., the memory 1206, the main memory 1216, the static memory 1218, and/or the (e.g., cache) memory of one or more of the processors 1204) and/or the storage unit 1220 may store one or more sets of instructions (e.g., software) and/or data structures embodying or used by any one or more of the methodologies or functions described herein. These instructions (e.g., the instructions 1202), when executed by one or more of the processors 1204, cause performance of various operations to implement various embodiments of the present disclosure.

The instructions 1202 may be transmitted or received over one or more networks 1224 using a transmission medium, via a network-interface device (e.g., a network-interface component included in the communication components 1244), and using any one of a number of transfer protocols (e.g., the Session Initiation Protocol (SIP), the HyperText Transfer Protocol (HTTP), and/or the like). Similarly, the instructions 1202 may be transmitted or received using a transmission medium via the coupling 1230 (e.g., a peer-to-peer coupling) to one or more devices 1226. In some embodiments, IoT devices can communicate using Message Queuing Telemetry Transport (MQTT) messaging, which can be relatively more compact and efficient.

FIG. 13 is a diagram 1300 illustrating an example software architecture 1302, which can be installed on any one or more of the devices described herein. For example, the software architecture 1302 could be installed on any device or system that is arranged similar to the computer system 1200 of FIG. 12. The software architecture 1302 may be supported by hardware such as a machine 1304 that may include processors 1306, memory 1308, and I/O components 1310. In this example, the software architecture 1302 can be conceptualized as a stack of layers, where each layer provides a particular functionality. The software architecture 1302 may include layers such an operating system 1312, libraries 1314, frameworks 1316, and applications 1318. Operationally, using one or more application programming interfaces (APIs), the applications 1318 may invoke API calls 1320 through the software stack and receive messages 1322 in response to the API calls 1320.

In at least one embodiment, the operating system 1312 manages hardware resources and provides common services. The operating system 1312 may include, as examples, a kernel 1324, services 1326, and drivers 1328. The kernel 1324 may act as an abstraction layer between the hardware and the other software layers. For example, the kernel 1324 may provide memory management, processor management (e.g., scheduling), component management, networking, and/or security settings, in some cases among one or more other functionalities. The services 1326 may provide other common services for the other software layers. The drivers 1328 may be responsible for controlling or interfacing with underlying hardware. For instance, the drivers 1328 may include display drivers, camera drivers, Bluetooth or Bluetooth Low Energy drivers, flash memory drivers, serial communication drivers (e.g., USB drivers), Wi-Fi drivers, audio drivers, power management drivers, and/or the like.

The libraries 1314 may provide a low-level common infrastructure used by the applications 1318. The libraries 1314 may include system libraries 1330 (e.g., a C standard library) that may provide functions such as memory-allocation functions, string-manipulation functions, mathematic functions, and/or the like. In addition, the libraries 1314 may include API libraries 1332 such as media libraries (e.g., libraries to support presentation and/or manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), Portable Network Graphics (PNG), and/or the like), graphics libraries (e.g., an OpenGL framework used to render in two dimensions (2D) and three dimensions (3D) in graphic content on a display), database libraries (e.g., SQLite to provide various relational-database functions), web libraries (e.g., WebKit to provide web-browsing functionality), and/or the like. The libraries 1314 may also include a wide variety of other libraries 1334 to provide many other APIs to the applications 1318.

The frameworks 1316 may provide a high-level common infrastructure that may be used by the applications 1318. For example, the frameworks 1316 may provide various graphical-user-interface (GUI) functions, high-level resource management, high-level location services, and/or the like. The frameworks 1316 may provide a broad spectrum of other APIs that may be used by the applications 1318, some of which may be specific to a particular operating system or platform.

Purely as representative examples, the applications 1318 may include a home application 1336, a contacts application 1338, a browser application 1340, a book-reader application 1342, a location application 1344, a media application 1346, a messaging application 1348, a game application 1350, and/or a broad assortment of other applications generically represented in FIG. 13 as a third-party application 1352. The applications 1318 may be programs that execute functions defined in the programs. Various programming languages may be employed to create one or more of the applications 1318, structured in a variety of manners, such as object-oriented programming languages (e.g., Objective-C, Java, C++, etc.), procedural programming languages (e.g., C, assembly language, etc.), and/or the like. In a specific example, the third-party application 1352 (e.g., an application developed using the ANDROID™ or IOS™ software development kit (SDK) by an entity other than the vendor of the particular platform) could be mobile software running on a mobile operating system such as IOS™, ANDROID™, WINDOWS® Phone, and/or the like. Moreover, a third-party application 1352 may be able to invoke the API calls 1320 provided by the operating system 1312 to facilitate functionality described herein.

In view of the disclosure above, a listing of various examples of embodiments is set forth below. It should be noted that one or more features of an example, taken in isolation or combination, should be considered to be within the disclosure of this application.

Example 1 is a passenger-assistance system for a vehicle, the passenger-assistance system including: first circuitry configured to perform one or more first-circuitry operations including identifying an assistance type of a passenger of the vehicle; second circuitry configured to perform one or more second-circuitry operations including controlling one or more passenger-comfort controls of the vehicle based on the identified assistance type; third circuitry configured to perform one or more third-circuitry operations including generating a modified route for a ride for the passenger at least in part by modifying an initial route for the ride based on the identified assistance type; and fourth circuitry configured to perform one or more fourth-circuitry operations including one or both of conducting a pre-ride safety check based on the identified assistance type and conducting a pre-exit safety check based on the identified assistance type.

Example 2 is the passenger-assistance system of Example 1, where the one or more first-circuitry operations further include obtaining a passenger profile associated with the passenger; and the identifying of the assistance type of the passenger is performed based at least in part on assistance-type data in the passenger profile, the assistance-type data indicating the assistance type of the passenger.

Example 3 is the passenger-assistance system of Example 1 or Example 2, further including fifth circuitry configured to perform one or more fifth-circuitry operations including collecting passenger feedback from the passenger during at least part of the ride, the one or more fifth-circuitry operations further including modifying the controlling of the one or more passenger-comfort controls based on the collected passenger feedback.

Example 4 is the passenger-assistance system of Example 3, the one or more fifth-circuitry operations further including collecting assistance-type-detection feedback from the passenger regarding an accuracy of the identified assistance type of the passenger, the one or more first-circuitry operations further including conducting an identification of an assistance type of at least one subsequent passenger of the vehicle based at least in part on the collected assistance-type-detection feedback.

Example 5 is the passenger-assistance system of Example 3 or Example 4, the one or more fifth-circuitry operations further including collecting trip-planning feedback from the passenger regarding the generated modified route for the ride, the one or more third-circuitry operations further including generating a modified route for at least one subsequent ride for at least one subsequent passenger based on the collected trip-planning feedback.

Example 6 is the passenger-assistance system of any of the Examples 1-5, the first circuitry including: a sensor array including at least one sensor configured to collect sensor data with respect to a given passenger of the vehicle; one or more circuits that implement a plurality of neural networks that have each been trained to calculate, based on the sensor data, a plurality of probabilities that each correspond to the given passenger having a different particular assistance type in a plurality of assistance types; and a class-fusion circuit configured to identify an assistance type of the given passenger based on the probabilities calculated by the neural networks in the plurality of neural networks.

Example 7 is the passenger-assistance system of Example 6, the plurality of assistance types including an assistance type associated with not needing assistance.

Example 8 is the passenger-assistance system of Example 6 or Example 7, where the plurality of neural networks includes a first neural network configured to calculate the plurality of probabilities based at least in part on an assistance-prompt subset of the sensor data; and the assistance-prompt subset of the sensor data indicates a response or lack of response from the given passenger to at least one assistance prompt presented to the given passenger via a user interface in the vehicle.

Example 9 is the passenger-assistance system of any of the Examples 6-8, where the plurality of neural networks includes a second neural network configured to calculate the plurality of probabilities based at least in part on a stimulated-response subset of the sensor data; and the stimulated-response subset of the sensor data indicates a reaction or a lack of reaction by the given passenger to one or more sensory stimuli presented in a defined area around the given passenger.

Example 10 is the passenger-assistance system of any of the Examples 6-9, where the plurality of neural networks includes a third neural network configured to use the sensor data to: calculate an estimated age of the given passenger; and calculate the plurality of probabilities based at least in part on the calculated estimated age of the given passenger.

Example 11 is the passenger-assistance system of any of the Examples 6-10, where the plurality of neural networks includes a fourth neural network configured to use the sensor data to: identify whether the given passenger has one or more assistance objects from among a plurality of assistance objects; and calculate the plurality of probabilities based at least in part on a lack of or presence of any identified assistance objects from among the plurality of assistance objects.

Example 12 is the passenger-assistance system of any of the Examples 1-11, where the initial route for the ride was generated from a first set of mapping data; and generating the modified route includes generating the modified route based at least in part on a second set of mapping data, the second set of mapping data being an accessibility-informed set of mapping data.

Example 13 is the passenger-assistance system of any of the Examples 1-12, where the first circuitry identifies that the assistance type of a given passenger of the vehicle is that the given passenger is an infant; and the second circuitry uses reinforcement learning and analysis of non-verbal indications of a comfort level of the infant in controlling one or more passenger-comfort controls with respect to the comfort level of the infant.

Example 14 is the passenger-assistance system of Example 13, where the second circuitry also uses, in controlling one or more passenger-comfort controls with respect to the comfort level of the infant, aggregated infant-comfort-related data from a cloud-based management system of a plurality of vehicles that includes the vehicle.

Example 15 is the passenger-assistance system of any of the Examples 1-14, where the first circuitry identifies that a given passenger is associated with multiple assistance types; the controlling of the one or more passenger-comfort controls of the vehicle is based on the multiple assistance types; the generating of the modified route for the ride is based on the multiple assistance types; and one or both of the conducting of the pre-ride safety check and the conducting of the pre-exit safety check is based on the multiple assistance types.

Example 16 is the passenger-assistance system of any of the Examples 1-15, where the modifying of the initial route for the ride based on the identified assistance type includes selecting a different drop-off location at a destination of the ride based on the identified assistance type.

Example 17 is at least one computer-readable storage medium containing instructions that, when executed by at least one hardware processor of a computer system, cause the computer system to perform operations including: receiving booking information for a ride for a passenger of a vehicle; conducting a pre-ride safety check for the ride based at least on the booking information; determining that the passenger is an assistance passenger of at least one identified assistance type from among a plurality of assistance types; customizing an in-vehicle experience for the assistance passenger, including controlling one or more passenger-comfort controls of the vehicle based on the at least one identified assistance type; generating a modified route for the ride at least in part by modifying an initial route for the ride based on the at least one identified assistance type; and conducting a pre-exit safety check based on the at least one identified assistance type.

Example 18 is the computer-readable storage medium of Example 17, the operations further including obtaining a passenger profile associated with the passenger, where the determining that the passenger is an assistance passenger of at least one identified assistance type from among the plurality of assistance types is performed based at least in part on assistance-type data in the passenger profile, the assistance-type data indicating the assistance type of the passenger.

Example 19 is the computer-readable storage medium of Example 17 or Example 18, the operations further including: collecting in-vehicle-experience feedback from the assistance passenger during at least part of the ride; and modifying the controlling of the one or more passenger-comfort controls of the vehicle based further on the collected in-vehicle-experience feedback.

Example 20 is the computer-readable storage medium of Example 19, the operations further including: collecting assistance-type-detection feedback from the passenger regarding an accuracy of the identified assistance type of the passenger; and determining that at least one subsequent passenger of the vehicle is an assistance passenger of at least one identified assistance type from among the plurality of assistance types based at least in part on the collected assistance-type-detection feedback.

Example 21 is the computer-readable storage medium of Example 19 or Example 20, the operations further including: collecting trip-planning feedback from the passenger regarding the generated modified route for the ride; and generating a modified route for at least one subsequent ride for at least one subsequent passenger based on the collected trip-planning feedback.

Example 22 is the computer-readable storage medium of any of the Examples 17-21, where determining that the passenger is an assistance passenger of the at least one identified assistance type from among the plurality of assistance types includes: using a sensor array including at least one sensor to collect sensor data with respect to the assistance passenger; using one or more circuits that implement a plurality of neural networks to calculate, based on the sensor data, a plurality of probabilities that each correspond to the given passenger having a different particular assistance type in the plurality of assistance types; and using a class-fusion circuit to identify the at least one identified assistance type of the assistance passenger based on the probabilities calculated by the neural networks in the plurality of neural networks.

Example 23 is the computer-readable storage medium of Example 22, the plurality of assistance types including an assistance type associated with not needing assistance.

Example 24 is the computer-readable storage medium of Example 22 or Example 23, where the plurality of neural networks includes a first neural network configured to calculate the plurality of probabilities based at least in part on an assistance-prompt subset of the sensor data; and the assistance-prompt subset of the sensor data indicates a response or lack of response from the given passenger to at least one assistance prompt presented to the given passenger via a user interface in the vehicle.

Example 25 is the computer-readable storage medium of any of the Examples 22-24, where the plurality of neural networks includes a second neural network configured to calculate the plurality of probabilities based at least in part on a stimulated-response subset of the sensor data; and the stimulated-response subset of the sensor data indicates a reaction or a lack of reaction by the given passenger to one or more sensory stimuli presented in a defined area around the given passenger.

Example 26 is the computer-readable storage medium of any of the Examples 22-25, where the plurality of neural networks includes a third neural network configured to use the sensor data to: calculate an estimated age of the given passenger; and calculate the plurality of probabilities based at least in part on the calculated estimated age of the given passenger.

Example 27 is the computer-readable storage medium of any of the Examples 22-26, where the plurality of neural networks includes a fourth neural network configured to use the sensor data to: identify whether the given passenger has one or more assistance objects from among a plurality of assistance objects; and calculate the plurality of probabilities based at least in part on a lack of or presence of any identified assistance objects from among the plurality of assistance objects.

Example 28 is the computer-readable storage medium of any of the Examples 17-27, where the initial route for the ride was generated from a first set of mapping data; and generating the modified route includes generating the modified route based at least in part on a second set of mapping data, the second set of mapping data being an accessibility-informed set of mapping data.

Example 29 is the computer-readable storage medium of any of the Examples 17-28, where the at least one identified assistance type includes that the given passenger is an infant; and the operations further include using reinforcement learning and analysis of non-verbal indications of a comfort level of the infant in the controlling of the one or more passenger-comfort controls of the vehicle with respect to the comfort level of the infant.

Example 30 is the computer-readable storage medium of Example 29, where the controlling of the one or more passenger-comfort controls of the vehicle with respect to the comfort level of the infant is also based on aggregated infant-comfort-related data from a cloud-based management system of a plurality of vehicles that includes the vehicle.

Example 31 is the computer-readable storage medium of any of the Examples 17-30, where the at least one identified assistance type includes multiple identified assistance types; the controlling of the one or more passenger-comfort controls of the vehicle is based on the multiple identified assistance types; the generating of the modified route for the ride is based on the multiple identified assistance types; and one or both of the conducting of the pre-ride safety check and the conducting of the pre-exit safety check is based on the multiple identified assistance types.

Example 32 is the computer-readable storage medium of any of the Examples 17-31, where the modifying of the initial route for the ride based on the at least one identified assistance type includes selecting a different drop-off location at a destination of the ride based on the at least one identified assistance type.

Example 33 is a method performed by a computer system by executing instructions on at least one hardware processor, the method including: receiving booking information for a ride for a passenger of an vehicle; conducting a pre-ride safety check for the ride based at least on the booking information; determining that the passenger is an assistance passenger of at least one identified assistance type from among a plurality of assistance types; customizing an in-vehicle experience for the assistance passenger, including controlling one or more passenger-comfort controls of the vehicle based on the at least one identified assistance type; generating a modified route for the ride at least in part by modifying an initial route for the ride based on the at least one identified assistance type; and conducting a pre-exit safety check based on the at least one identified assistance type.

Example 34 is the method of Example 33, further including obtaining a passenger profile associated with the passenger, where the determining that the passenger is an assistance passenger of at least one identified assistance type from among the plurality of assistance types is performed based at least in part on assistance-type data in the passenger profile, the assistance-type data indicating the assistance type of the passenger.

Example 35 is the method of Example 33 or Example 34, further including: collecting in-vehicle-experience feedback from the assistance passenger during at least part of the ride; and modifying the controlling of the one or more passenger-comfort controls of the vehicle based further on the collected in-vehicle-experience feedback.

Example 36 is the method of Example 35, further including: collecting assistance-type-detection feedback from the passenger regarding an accuracy of the identified assistance type of the passenger; and determining that at least one subsequent passenger of the vehicle is an assistance passenger of at least one identified assistance type from among the plurality of assistance types based at least in part on the collected assistance-type-detection feedback.

Example 37 is the method of Example 35 or Example 36, further including: collecting trip-planning feedback from the passenger regarding the generated modified route for the ride; and generating a modified route for at least one subsequent ride for at least one subsequent passenger based on the collected trip-planning feedback.

Example 38 is the method of any of the Examples 33-37, where determining that the passenger is an assistance passenger of the at least one identified assistance type from among the plurality of assistance types includes: using a sensor array including at least one sensor to collect sensor data with respect to the assistance passenger; using one or more circuits that implement a plurality of neural networks to calculate, based on the sensor data, a plurality of probabilities that each correspond to the given passenger having a different particular assistance type in the plurality of assistance types; and using a class-fusion circuit to identify the at least one identified assistance type of the assistance passenger based on the probabilities calculated by the neural networks in the plurality of neural networks.

Example 39 is the method of Example 38, the plurality of assistance types including an assistance type associated with not needing assistance.

Example 40 is the method of Example 38 or Example 39, where the plurality of neural networks includes a first neural network configured to calculate the plurality of probabilities based at least in part on an assistance-prompt subset of the sensor data; and the assistance-prompt subset of the sensor data indicates a response or lack of response from the given passenger to at least one assistance prompt presented to the given passenger via a user interface in the vehicle.

Example 41 is the method of any of the Examples 38-40, where the plurality of neural networks includes a second neural network configured to calculate the plurality of probabilities based at least in part on a stimulated-response subset of the sensor data; and the stimulated-response subset of the sensor data indicates a reaction or a lack of reaction by the given passenger to one or more sensory stimuli presented in a defined area around the given passenger.

Example 42 is the method of any of the Examples 38-41, where the plurality of neural networks includes a third neural network configured to use the sensor data to: calculate an estimated age of the given passenger; and calculate the plurality of probabilities based at least in part on the calculated estimated age of the given passenger.

Example 43 is the method of any of the Examples 38-42, where the plurality of neural networks includes a fourth neural network configured to use the sensor data to: identify whether the given passenger has one or more assistance objects from among a plurality of assistance objects; and calculate the plurality of probabilities based at least in part on a lack of or presence of any identified assistance objects from among the plurality of assistance objects.

Example 44 is the method of any of the Examples 33-43, where the initial route for the ride was generated from a first set of mapping data; and generating the modified route includes generating the modified route based at least in part on a second set of mapping data, the second set of mapping data being an accessibility-informed set of mapping data.

Example 45 is the method of any of the Examples 33-44, where the at least one identified assistance type includes that the given passenger is an infant; and the method further includes further include using reinforcement learning and analysis of non-verbal indications of a comfort level of the infant in the controlling of the one or more passenger-comfort controls of the vehicle with respect to the comfort level of the infant.

Example 46 is the method of Example 45, where the controlling of the one or more passenger-comfort controls of the vehicle with respect to the comfort level of the infant includes using aggregated infant-comfort-related data from a cloud-based management system of a plurality of vehicles that includes the vehicle.

Example 47 is the method of any of the Examples 33-46, where the at least one identified assistance type includes multiple identified assistance types; the controlling of the one or more passenger-comfort controls of the vehicle is based on the multiple identified assistance types; the generating of the modified route for the ride is based on the multiple identified assistance types; and one or both of the conducting of the pre-ride safety check and the conducting of the pre-exit safety check is based on the multiple identified assistance types.

Example 48 is the method of any of the Examples 43-47, where the modifying of the initial route for the ride based on the at least one identified assistance type includes selecting a different drop-off location at a destination of the ride based on the at least one identified assistance type.

To promote an understanding of the principles of the present disclosure, various embodiments are illustrated in the drawings. The embodiments disclosed herein are not intended to be exhaustive or to limit the present disclosure to the precise forms that are disclosed in the above detailed description. Rather, the described embodiments have been selected so that others skilled in the art may utilize their teachings. Accordingly, no limitation of the scope of the present disclosure is thereby intended.

As used in this disclosure, including in the claims, phrases of the form “at least one of A and B,” “at least one of A, B, and C,” and the like should be interpreted as if the language “A and/or B,” “A, B, and/or C,” and the like had been used in place of the entire phrase. Unless explicitly stated otherwise in connection with a particular instance, this manner of phrasing is not limited in this disclosure to meaning only “at least one of A and at least one of B,” “at least one of A, at least one of B, and at least one of C,” and so on. Rather, as used herein, the two-element version covers each of the following: one or more of A and no B, one or more of B and no A, and one or more of A and one or more of B. And similarly for the three-element version and beyond. Similar construction should be given to such phrases in which “one or both,” “one or more,” and the like is used in place of “at least one,” again unless explicitly stated otherwise in connection with a particular instance.

In any instances in this disclosure, including in the claims, in which numeric modifiers such as first, second, and third are used in reference to components, data (e.g., values, identifiers, parameters, and/or the like), and/or any other elements, such use of such modifiers is not intended to denote or dictate any specific or required order of the elements that are referenced in this manner. Rather, any such use of such modifiers is intended to assist the reader in distinguishing elements from one another, and should not be interpreted as insisting upon any particular order or carrying any other significance, unless such an order or other significance is clearly and affirmatively explained herein.

Furthermore, in this disclosure, in one or more embodiments, examples, and/or the like, it may be the case that one or more components of one or more devices, systems, and/or the like are referred to as modules that carry out (e.g., perform, execute, and the like) various functions. With respect to any such usages in the present disclosure, a module includes both hardware and instructions. The hardware could include one or more processors, one or more microprocessors, one or more microcontrollers, one or more microchips, one or more application-specific integrated circuits (ASICs), one or more field programmable gate arrays (FPGAs), one or more graphical processing units (GPUs), one or more tensor processing units (TPUs), and/or one or more devices and/or components of any other type deemed suitable by those of skill in the art for a given implementation.

In at least one embodiment, the instructions for a given module are executable by the hardware for carrying out the one or more herein-described functions of the module, and could include hardware (e.g., hardwired) instructions, firmware instructions, software instructions, and/or the like, stored in any one or more non-transitory computer-readable storage media deemed suitable by those of skill in the art for a given implementation. Each such non-transitory computer-readable storage medium could be or include memory (e.g., random access memory (RAM), read-only memory (ROM), erasable programmable read-only memory (EPROM), electrically erasable programmable read-only memory (EEPROM a.k.a. E2PROM), flash memory, and/or one or more other types of memory) and/or one or more other types of non-transitory computer-readable storage medium. A module could be realized as a single component or be distributed across multiple components. In some cases, a module may be referred to as a unit.

Moreover, consistent with the fact that the entities and arrangements that are described herein, including the entities and arrangements that are depicted in and described in connection with the drawings, are presented as examples and not by way of limitation, any and all statements or other indications as to what a particular drawing “depicts,” what a particular element or entity in a particular drawing or otherwise mentioned in this disclosure “is” or “has,” and any and all similar statements that are not explicitly self-qualifying by way of a clause such as “In at least one embodiment,” and that could therefore be read in isolation and out of context as absolute and thus as a limitation on all embodiments, can only properly be read as being constructively qualified by such a clause. It is for reasons akin to brevity and clarity of presentation that this implied qualifying clause is not repeated ad nauseum in this disclosure.

1.-25. (canceled)

26. A passenger-assistance system for a vehicle, the passenger-assistance system comprising:
first circuitry configured to perform one or more first-circuitry operations including identifying an assistance type of a passenger of the vehicle;
second circuitry configured to perform one or more second-circuitry operations including controlling one or more passenger-comfort controls of the vehicle based on the identified assistance type;
third circuitry configured to perform one or more third-circuitry operations including generating a modified route for a ride for the passenger at least in part by modifying an initial route for the ride based on the identified assistance type; and
fourth circuitry configured to perform one or more fourth-circuitry operations including one or both of conducting a pre-ride safety check based on the identified assistance type and conducting a pre-exit safety check based on the identified assistance type.

27. The passenger-assistance system of claim 26, wherein:
the one or more first-circuitry operations further include obtaining a passenger profile associated with the passenger; and
the identifying of the assistance type of the passenger is performed based at least in part on assistance-type data in the passenger profile, the assistance-type data indicating the assistance type of the passenger.

28. The passenger-assistance system of claim 26, further comprising fifth circuitry configured to perform one or more fifth-circuitry operations including collecting passenger feedback from the passenger during at least part of the ride, the one or more fifth-circuitry operations further including modifying the controlling of the one or more passenger-comfort controls based on the collected passenger feedback.

29. The passenger-assistance system of claim 28, the one or more fifth-circuitry operations further including collecting assistance-type-detection feedback from the passenger regarding an accuracy of the identified assistance type of the passenger, the one or more first-circuitry operations further including conducting an identification of an assistance type of at least one subsequent passenger of the vehicle based at least in part on the collected assistance-type-detection feedback.

30. The passenger-assistance system of claim 28, the one or more fifth-circuitry operations further including collecting trip-planning feedback from the passenger regarding the generated modified route for the ride, the one or more third-circuitry operations further including generating a modified route for at least one subsequent ride for at least one subsequent passenger based on the collected trip-planning feedback.

31. The passenger-assistance system of claim 26, the first circuitry comprising:
a sensor array comprising at least one sensor configured to collect sensor data corresponding to a respective passenger of the vehicle;
one or more circuits that implement a plurality of neural networks that have each been trained to calculate, based on the sensor data, a plurality of probabilities that each correspond to the respective passenger having a different particular assistance type in a plurality of assistance types; and
a class-fusion circuit configured to identify an assistance type of the respective passenger based on the probabilities calculated by the neural networks in the plurality of neural networks.

32. The passenger-assistance system of claim 31, the plurality of assistance types including an assistance type associated with not needing assistance.

33. The passenger-assistance system of claim 31, wherein:
the plurality of neural networks includes a first neural network configured to calculate the plurality of probabilities based at least in part on an assistance-prompt subset of the sensor data; and
the assistance-prompt subset of the sensor data indicates a response or lack of response from the respective passenger to at least one assistance prompt presented to the respective passenger via a user interface in the vehicle.

34. The passenger-assistance system of claim 31, wherein:
the plurality of neural networks includes a second neural network configured to calculate the plurality of probabilities based at least in part on a stimulated-response subset of the sensor data; and
the stimulated-response subset of the sensor data indicates a reaction or a lack of reaction by the respective passenger to one or more sensory stimuli presented in a defined area around the respective passenger.

35. The passenger-assistance system of claim 31, wherein the plurality of neural networks includes a third neural network configured to use the sensor data to:
calculate an estimated age of the respective passenger; and
calculate the plurality of probabilities based at least in part on the calculated estimated age of the respective passenger.

36. The passenger-assistance system of claim 31, wherein the plurality of neural networks includes a fourth neural network configured to use the sensor data to:
identify whether the respective passenger has one or more assistance objects from among a plurality of assistance objects; and
calculate the plurality of probabilities based at least in part on a lack of or presence of any identified assistance objects from among the plurality of assistance objects.

37. The passenger-assistance system of claim 26, wherein:
the initial route for the ride was generated from a first set of mapping data; and
generating the modified route comprises generating the modified route based at least in part on a second set of mapping data, the second set of mapping data being an accessibility-informed set of mapping data.

38. The passenger-assistance system of claim 26, wherein:
the first circuitry identifies that the assistance type of a respective passenger of the vehicle is that the respective passenger is an infant; and
the second circuitry uses reinforcement learning and analysis of non-verbal indications of a comfort level of the infant in controlling one or more passenger-comfort controls with respect to the comfort level of the infant;
wherein the second circuitry also uses, in controlling one or more passenger-comfort controls with respect to the comfort level of the infant, aggregated infant-comfort-related data from a cloud-based management system of a plurality of vehicles that includes the vehicle.

39. The passenger-assistance system of claim 26, wherein:
the first circuitry identifies that a respective passenger is associated with multiple assistance types;
the controlling of the one or more passenger-comfort controls of the vehicle is based on the multiple assistance types;
the generating of the modified route for the ride is based on the multiple assistance types; and
one or both of the conducting of the pre-ride safety check and the conducting of the pre-exit safety check is based on the multiple assistance types.

40. The passenger-assistance system of claim 26, wherein the modifying of the initial route for the ride based on the identified assistance type comprises selecting a different drop-off location at a destination of the ride based on the identified assistance type.

41. At least one non-transitory computer-readable storage medium containing instructions that, when executed by at least one hardware processor of a computer system, cause the computer system to perform operations comprising:
receiving booking information for a ride for a passenger of a vehicle;
conducting a pre-ride safety check for the ride based at least on the booking information;
determining that the passenger is an assistance passenger of at least one identified assistance type from among a plurality of assistance types;
customizing an in-vehicle experience for the assistance passenger, including controlling one or more passenger-comfort controls of the vehicle based on the at least one identified assistance type;
generating a modified route for the ride at least in part by modifying an initial route for the ride based on the at least one identified assistance type; and
conducting a pre-exit safety check based on the at least one identified assistance type.

42. The computer-readable storage medium of claim 41, the operations further comprising:
collecting in-vehicle-experience feedback from the assistance passenger during at least part of the ride; and
modifying the controlling of the one or more passenger-comfort controls based on the collected in-vehicle-experience feedback.

43. The computer-readable storage medium of claim 41, wherein determining that the passenger is an assistance passenger of the at least one identified assistance type from among the plurality of assistance types comprises:
using a sensor array comprising at least one sensor to collect sensor data with respect to the assistance passenger;
using one or more circuits that implement a plurality of neural networks to calculate, based on the sensor data, a plurality of probabilities that each correspond to the respective passenger having a different particular assistance type in the plurality of assistance types; and
using a class-fusion circuit to identify the at least one identified assistance type of the assistance passenger based on the probabilities calculated by the neural networks in the plurality of neural networks.

44. The computer-readable storage medium of claim 41, wherein:
the initial route for the ride was generated from a first set of mapping data; and
generating the modified route comprises generating the modified route based at least in part on a second set of mapping data, the second set of mapping data being an accessibility-informed set of mapping data.

45. The computer-readable storage medium of claim 41, wherein:
the at least one identified assistance type comprises multiple identified assistance types;
the controlling of the one or more passenger-comfort controls of the vehicle is based on the multiple identified assistance types;
the generating of the modified route for the ride is based on the multiple identified assistance types; and
one or both of the conducting of the pre-ride safety check and the conducting of the pre-exit safety check is based on the multiple identified assistance types.
